(19) United States
(12) Patent Application Publication
(10) Pub. No.: US 2011/0274948 A1
(43) Pub. Date: Nov. 10, 2011

(54) ENERGY TRANSFER USING ELECTROCHEMICALLY ISOLATED FLUIDS

(75) Inventors: Mihai Duduta, Cambridge, MA (US); W. Craig Carter, Jamaica Plain, MA (US); Yet-Ming Chiang, Framingham, MA (US); Bryan Y. Ho, Cambridge, MA (US); Victor Brunini, Cambridge, MA (US)

(73) Assignee: Massachusetts Institute of Technology, Cambridge, MA (US)

(21) Appl. No.: 13/083,167

(22) Filed: Apr. 8, 2011

Related U.S. Application Data
(60) Provisional application No. 61/322,599, filed on Apr. 9, 2010.
(60) Provisional application No. 61/374,934, filed on Aug. 18, 2010.
(60) Provisional application No. 61/424,033, filed on Dec. 16, 2010.

(51) Int. Cl. H01M 10/44

(52) U.S. Cl. 429/50

(57) ABSTRACT

The present invention is related to energy generation using electrochemically isolated fluids, and articles, systems, and methods for achieving the same. The embodiments described herein can be used in electrochemical cells in which at least one electrode comprises an electrochemically active fluid (i.e., the electrochemical cell comprises at least one fluid comprising electrode active material that is flowable into and/or out of the electrode compartment in which the electrode active material is charged and/or discharged).

### RELATED APPLICATIONS

This application claims priority under 35 U.S.C. §119(e) to U.S. Provisional Patent Application No. 61/322,599, filed Apr. 9, 2010, and entitled “Energy Grid Storage Using Rechargeable Power Sources”; U.S. Provisional Patent Application No. 61/374,934, filed Aug. 18, 2010, and entitled “Electrochemical Flow Cells”; and U.S. Provisional Patent Application No. 61/424,033, filed Dec. 16, 2010, and entitled “Energy Generation Using Electrochemically Isolated Fluids”; each of which is incorporated herein by reference in its entirety for all purposes.

### FIELD OF INVENTION

Energy transfer using electrochemically isolated fluids, and articles, systems, and methods for achieving the same, are generally described.

### BACKGROUND

A battery stores electrochemical energy by separating an ion source and an ion sink at differing ion electrochemical potential. A difference in electrochemical potential produces a voltage difference between the positive and negative electrodes, which can be used to produce an electric current if the electrodes are connected by a conductive element. A rechargeable battery can be recharged by application of an opposing voltage difference that drives electronic current and ionic current in an opposite direction as that of a discharging battery in service. In rechargeable batteries, the electrode active materials generally need to be able to accept and provide ions.

Rechargeable batteries can be constructed using solid, static negative electrode/electrolyte and positive electrode/electrolyte media. In this case, non-energy storing elements of the device comprise a fixed volume or mass fraction of the device; thereby decreasing the device's energy and power density. The rate at which current can be extracted is also limited by the distance over which cations can be conducted. Thus, in many cases, power requirements of static cells constrain the total capacity by limiting device length scales.

Redox flow batteries are energy storage devices in which the positive and negative electrode active materials are soluble metal ions in liquid solution that are oxidized or reduced during the operation of the cell. However, for various reasons, redox flow batteries typically have relatively small energy densities and specific energies. Thus, there remains a need for high energy-density and high power-density energy storage devices.

### SUMMARY OF THE INVENTION

Energy transfer using electrochemically isolated fluids, and articles, systems, and methods for achieving the same, are provided. The subject matter of the present invention involves, in some cases, interrelated products, alternative solutions to a particular problem, and/or a plurality of different uses of one or more systems and/or articles.

In one aspect, a method of transferring energy in an energy storage device is described. In some embodiments, the method comprises transporting an electrochemically active fluid through an electrode compartment; inhibiting the flow of the electrochemically active fluid; and during and/or after inhibiting the flow of the electrochemically active fluid, at least partially charging or discharging a first portion of the electrochemically active fluid while, at the same time, a second portion of the electrochemically active fluid fluidically connected to the first portion via an open flow path is not substantially charged or discharged.

In some embodiments, the method comprises at least partially discharging a first portion of an electrochemically active fluid within a first volume; urging the first portion of the electrochemically active fluid from the first volume to a second volume; and at least partially charging the first portion of the electrochemically active fluid within the second volume. In some embodiments, the first and second volumes remain fluidically connected by a continuous, open conduit during the charging and discharging of the first portion of the electrochemically active fluid.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIGS. 1A-1B include schematic cross-sectional illustrations of an energy storage device comprising an electrochemically active fluid, according to one set of embodiments;

FIG. 2 includes, according to some embodiments, a schematic cross-sectional illustration of a system comprising two charge/discharge devices comprising an electrochemically active fluid;

FIG. 3 includes a schematic cross-sectional illustration of a system comprising two charge/discharge devices comprising an electrochemically active fluid, according to some embodiments;

FIGS. 4A-4D include: (A) a cross-sectional schematic illustration of an assembled half flow testing cell, (B) a photo of the components of a half flow cell prior to assembly, (C) a photo of an assembled half flow cell, and (D) a test cell assembled in a peristaltic pump, according to one set of embodiments;

FIGS. 5A-5B include, according to one set of embodiments, plots of voltage, capacity, and current as a function of time;

FIG. 6 includes, according to one set of embodiments, a photograph of an assembled half cell used for an intermittent flow test;

FIGS. 7A-7C include: (A) plots of voltage, capacity, and current as a function of time, (B) plots of voltage, theoretical % charge of material, and current as a function of time, and (C) plots of voltage, capacity, and current as a function of time, according to one set of embodiments;

FIG. 8 includes, according to one set of embodiments, a photograph of an assembled full cell used for an intermittent flow test;

FIG. 9 includes plots of voltage, anode capacity, and current as a function of time, according to one set of embodiments.

### DETAILED DESCRIPTION

The present invention is related to energy transfer using electrochemically isolated fluids, and articles, systems, and methods for achieving the same. The embodiments described herein can be used in electrochemical cells in which at least one electrode comprises an electrochemically active fluid (i.e., the electrochemical cell comprises at least one fluid comprising electrode active material that is flowable into and/or out of the electrode compartment in which the electrode active material is charged and/or discharged). For example, in some embodiments, a semi-solid flow cell (SSFC) is described, wherein a solid electrode active material is suspended in an electrolytic fluid. The suspension can be transported to an electrode compartment where the electrode active material can participate in an electrochemical reaction, thereby storing and/or releasing energy.

In many energy storage systems with flow-based electrodes (e.g., in flow batteries, redox flow devices, etc.), unwanted electrochemical communication can reduce system performance. For example, electrochemically active fluid within an electrode compartment can electrochemically communicate with portions of the fluid upstream and/or downstream of the electrode compartment. In some such cases, ions and/or electrons can be transported out of the electrode compartment, which can reduce the amount of power and/or energy output by the energy storage device.

It has been discovered that such losses can be reduced by operating the cell such that a portion of an electrochemically active fluid is electrochemically isolated within an electrode compartment from portions of the electrochemically active fluid upstream and/or downstream of the electrode compartment. Isolation of the electrochemically active fluid can be achieved, for example, by charging and/or discharging the fluid at a sufficiently high rate to inhibit upstream and downstream transport of ions and/or electrons. In addition, isolation of an electrochemically active fluid can be achieved by selecting an appropriate electronic conductivity for the fluid; for example, relatively low electronic conductivities can be employed when charging and/or discharging is relatively slow, and relatively high electronic conductivities can be employed when charging and/or discharging is relatively fast. Not wishing to be bound by any particular theory, it is believed that, when the charging and/or discharging rate is sufficiently high and/or the electronic conductivity is sufficiently low, ions will follow the path of least resistance across the ion-exchange medium, and electrons will follow the path of least resistance along an electronically conductive circuit connected to the electrode current collectors. By inhibiting the transport of ions and electrons out of the portion of electrochemically active fluid within the electrode compartment, one can increase the degree to which the ions and/or electrons are available to participate in an electrochemical reaction, for example, by being transported through an ion-exchange medium such as a membrane separator (in the case of ions) and/or through an external circuit (in the case of electrons). Restricting the transport of ions and/or electrons can enhance the power, discharge duration, specific energy, energy density, and/or other performance characteristics of the energy storage device.

Accordingly, in some embodiments, a first portion of an electrochemically active fluid can be disposed within an electrode compartment, and a second portion of the electrochemically active fluid can be in fluid communication with the first portion via an open flow pathway. The first portion of electrochemically active fluid can be at least partially charged and/or discharged while the second portion is not substantially charged and/or discharged. When charging and/or discharging of an electrochemically active fluid is performed in this manner, a large portion (if not all) of the electrochemically active ions and/or electrons can be confined to the electrochemically active fluid within the electrode compartment, thereby increasing the amount of energy that can be generated relative to situations in which the electrochemical fluid is not isolated.

It has also been discovered that the performance of energy storage devices can be enhanced by transporting multiple portions of an electrochemically active fluid (e.g., “plugs” of electrochemically active fluid) to the energy storage device, and charging and/or discharging the portions of the electrochemically active fluid in succession. Such an arrangement can be achieved, for example, by intermittently transporting first, second, and/or more portions of electrochemically active fluids to an electrode compartment and operating the device such that the portion of the electrochemically active fluid proximate the electrode compartment is electrochemically isolated from upstream and downstream portions of the electrochemically active fluid.

Accordingly, in some embodiments, a first portion of an electrochemically active fluid can be transported into an electrode compartment, after which, the flow of the electrochemically active fluid can be inhibited. During and/or after inhibiting the flow of the electrochemically active fluid, the first portion of electrochemically active fluid can be at least partially charged and/or discharged while, at the same time, a second portion of the electrochemically active fluid, fluidically connected to the first portion via an open flow pathway, is not substantially charged and/or discharged. In some embodiments, after at least partially charging and/or discharging the first portion of electrochemically active fluid, the flow rate of the electrochemically fluid can be increased. Increasing the flow rate of the electrochemically active fluid can result in the first portion of electrochemically active fluid being transported out of the electrode compartment and the second portion of electrochemically active fluid being transported into the electrode compartment. In some embodiments, after the second portion of electrochemically active fluid has been transported into the electrode compartment, flow of the electrochemically active fluid can be inhibited a second time. During and/or after inhibiting flow a second time, the second portion of electrochemically active fluid can be charged and/or discharged while the first portion (and/or a third portion) of the electrochemically active fluid is not substantially charged and/or discharged. Operation of the device can continue in this manner for any number of portions of the electrochemically active fluid. When operated in this manner, multiple “plugs” of electrochemically isolated, electrochemically active fluid can be locally charged and/or discharged and, during each charging and/or discharging step, other portions of the electrochemically active fluid are not substantially charged and/or discharged.

The systems, articles, and methods described herein can provide a variety of advantages over other energy storage devices. As one example, the use of intermittent flow (as opposed to continuous flow) can reduce the amount of energy required to transport the fluid through the electrode compartment to achieve a given state of charge. For example, in some embodiments, substantially all of the electrochemically active fluid can be charged and/or discharged to a given state of charge by intermittently transporting the electrochemically active fluid once through the electrode compartment. In some such cases, the use of a continuous flow regime might require the same fluid to be circulated through the electrode compartment multiple times (e:g., 2, 3, 4, 5, or more times) in order to achieve the same state of charge.

In addition, as noted above, electrochemical isolation of the electrode active material within an electrochemical cell can increase the power output, discharge duration, energy density, and/or specific energy of the electrochemical cell, relative to systems in which electrochemical isolation is not employed. Moreover, the energy storage devices and associated methods described herein allow for the decoupling of power components from energy storage components, for example, by allowing one to charge electrochemically active fluid in a location separate from the energy storage device in which it is later used to generate power. Directly replacing spent redox active material with charged redox active material can allow for faster, more efficient re-charging of the system.

Electrochemical isolation of electrochemically active fluids can be useful in variety of systems that employ flowable redox active materials. For example, electrochemical isolation can be useful in association with redox flow energy storage devices, including those employing semi-solid and/or redox active ion-storing liquid reactants (also referred to as condensed ion-storing liquid reactants), such as those described in U.S. patent application Ser. No. 12/484,113, filed Jun. 12, 2009, and entitled “High Energy Density Redox Flow Device,” and in U.S. patent application Ser. No. 12/970,753, filed Dec. 16, 2010, and entitled “High Energy Density Redox Flow Device,” each of which is incorporated herein by reference in its entirety for all purposes. Electrochemical isolation can also be useful in traditional redox flow batteries employing electrode active materials dissolved in electrolyte carrier fluids. In one set of embodiments, the energy storage systems described herein provide a high enough specific energy to permit, for example, extended driving range for an electric vehicle, or provide a substantial improvement in specific energy or energy density over conventional redox batteries for stationary energy storage, including for example applications in grid services or storage of intermittent renewable energy sources such as wind and solar power.

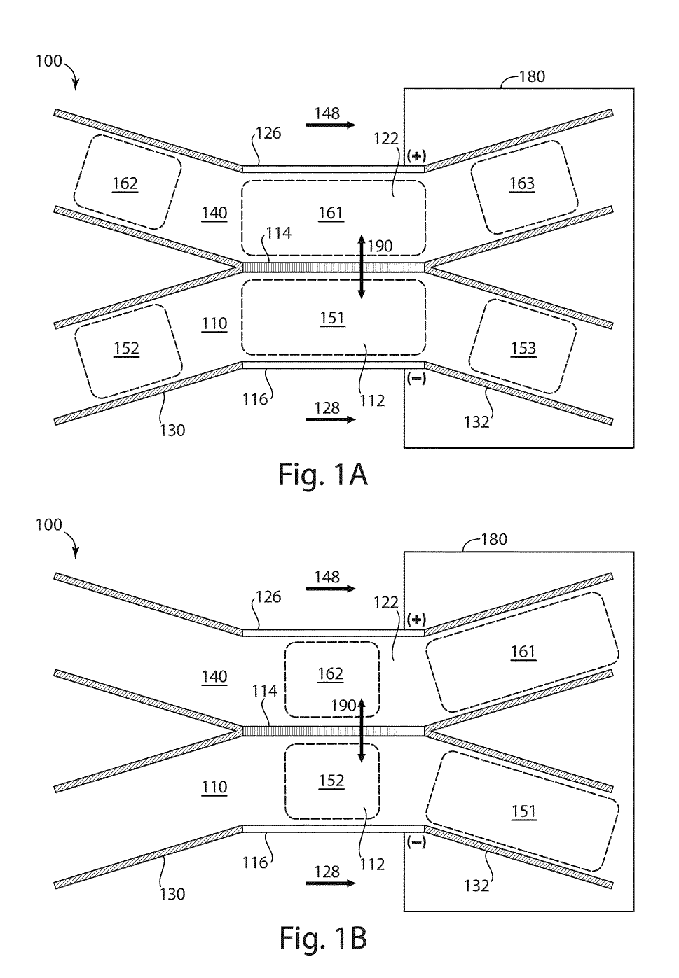

FIGS. 1A-1B include exemplary cross-sectional schematic illustrations of energy storage system 100 which can be operated such that electrochemically isolated portions of an electrochemically active fluid (e.g., electrochemically active fluid 110) can be charged and/or discharged while one and/or more other portions of the electrochemically active fluid are not substantially charged and/or discharged. As used herein, the terms “electrochemically active fluid” and “flowable redox active composition” are used interchangeably to refer to fluid compositions that contain any electrode active material in a concentration sufficiently high to allow for operation of the energy storage device at its intended level. In some embodiments, the ionic conductivity of the working ion of the energy storage device (e.g., Li+ for lithium-ion based devices) within the electrochemically active fluid can be at least about 0.001 mS/cm, at least about 0.01 mS/cm, at least about 0.1 mS/cm, at least about 1 mS/cm, between about 0.001 and about 100 mS/cm, between about 0.01 and about 10 mS/cm, between about 0.01 mS/cm and about 100 mS/cm, or between about 0.01 and about 10 mS/cm at the temperature at which the energy storage device is operated (e.g., at least one temperature between about −50° C. and about +50° C.).

The term “electrode active material,” as used herein, refers to any material capable of taking up and/or releasing ions and electrons during operation of the cell. The term “anode active material” is used to refer to electrode active materials associated with the anode, while the term “cathode active material” is used to refer to electrode active materials associated with the cathode. It should be understood that, as used herein, an electrode active material is not the same as an electrolyte. The term “electrolyte” is used herein to refer to material that does not itself take up or release ions, but rather, facilitates transport of ions to and/or from electrode active material contained within the electrolyte to other parts of the energy storage system. Furthermore, the electrode active materials do not include materials that are added to facilitate the transport of electrons from an electrode current collector to the electrode active material (i.e., additional materials that increase the electronic conductivity).

Energy storage system 100 includes an electrode compartment 112 that is bounded by an ion-exchange medium 114 and an electrode current collector 116. As used herein, the term “electrode current collector” refers to the portion of the energy storage system that conducts electrons away from the electrode compartment but does not substantially participate in the electrochemical reaction. An electrode current collector can comprise, in some embodiments, a metal sheet or piece of carbon in electronic communication with an electrochemically active fluid within the electrode compartment.

The electrode current collector and the ion-exchange medium can at least partially define an electrode compartment. In the set of embodiments illustrated in FIGS. 1A-1B, ion-exchange medium 114 forms a first boundary of electrode compartment 112, and electrode current collector 116 forms a second boundary of electrode compartment 112. An electrode compartment can also include one or more other boundaries formed of material that does not serve as either the electrode current collector or the ion-exchange medium. While the ion-exchange medium and the electrode current collector are illustrated as defining opposite sides of the electrode compartment in FIGS. 1A-1B, it should be understood that other arrangements are also possible. One of ordinary skill in the art, given the present disclosure, would be capable of designing a variety of configurations of the electrode current collector and the ion-exchange medium while maintaining operability of the energy storage system.

The energy storage system can also include a second electrode compartment and a second electrode current collector. In the set of embodiments illustrated in FIGS. 1A-1B, system 100 includes a second electrode current collector 126 positioned on the side of ion-exchange medium 114 opposite current collector 116. In addition, electrode current collector 126 and ion-exchange medium 114 define a second electrode compartment 122. In the set of embodiments illustrated in FIGS. 1A-1B, electrode compartment 112 contains an electrochemically active fluid 140 comprising anode active material (and electrode current collector 116 is anodic) while electrode compartment 122 contains an electrochemically active fluid 110 comprising cathode active material (and electrode current collector 126 is cathodic). In other embodiments, however, electrode compartment 112 can contain a cathode active material (and electrode current collector 116 can be cathodic) while electrode compartment 122 can contain an anode active material (and electrode current collector 126 can be anodic).

The first and/or second electrode compartments can be arranged such that electrochemically active fluid is transported through the compartments to generate energy (via discharge) and/or recharge depleted electrode active material (via charging). In the set of embodiments illustrated in FIGS. 1A-1B, electrochemically active fluid 110 containing anode active material can be transported through electrode compartment 112 (e.g., as part of a redox flow energy storage device) in the direction of arrow 128. In some embodiments, electrochemically active fluid 140 containing cathode active material can be transported through electrode compartment 122 in the direction of arrow 148. While co-current flow is illustrated in FIGS. 1A-1B, it should be understood that, in other embodiments, countercurrent flow can also be used. In addition, the flow of electrochemically active fluids can be reversed, for example, when alternating between charging and discharging operations. While the set of embodiments illustrated in FIGS. 1A-1B includes electrochemically active fluids in both electrode compartments, it should be understood that, in other embodiments, the positive or negative electrochemically active fluid can be replaced with a conventional stationary electrode.

Electrochemically active fluids can be transported into and/or out of electrode compartments using a transporting device, such as a pump. For example, the transporting device can be used to transport fresh, charged positive and/or negative electrochemically active fluids into the positive and negative electrode compartments, respectively. The transporting device can be used, in some cases, to transport depleted positive and/or negative electrochemically active fluids out of the positive and negative electrode compartments, respectively. Any suitable transporting device can be used to transport electrochemically active fluids into and/or out of the electrode compartment(s). For instance, the transporting device can be a pump or any other conventional device for fluid transport. In some embodiments, the transporting device is a peristaltic pump.

An electrochemically active fluid can be disposed such that it is in electrochemical communication with ion-exchange medium and/or an electrochemically active material (either in a stationary solid or in a fluid) in a second electrode compartment, for example, as part of an electrochemical energy storage and/or transfer device. As used herein, two components are in “electrochemical communication” with each other when they are arranged such that they are capable of exchanging ions as part of an electrochemical reaction at a level sufficient to operate a device utilizing the components at its intended level. For example, in the set of embodiments illustrated in FIGS. 1A-1B, the portion of electrochemically active fluid 110 within electrode compartment 112 can electrochemically communicate with ion-exchange medium 114 when ions are transported from electrochemically active fluid 110 to ion-exchange medium 114, after which, the ions may be further transported, for example, to the portion of electrochemically active fluid 140 within electrode compartment 122 as part of an electrochemical reaction.

During operation, the cathode active material and the anode active material can undergo reduction and oxidation. Ions can move across ion-exchange medium 114, for example, along double-arrow 190. During discharging operation, the difference in electrochemical potentials of the positive and negative electrode active materials of the redox flow device can produce a voltage difference between the positive and negative electrode current collectors; the voltage difference can produce an electric current if the electrode current collectors are connected in a conductive circuit. In the set of embodiments illustrated in FIGS. 1A-1B, electrons can flow through external circuit 180 to generate current.

Energy storage devices can also be operated in charging mode. During charging operation, the electrode compartment containing a depleted electrochemically active fluid can be run in reverse, for example, by applying a voltage across the electrode current collectors sufficiently high to drive electronic current and ionic current in a direction opposite to that of discharging and reverse the electrochemical reaction of discharging, thereby charging the electrode active material within the positive and negative electrode compartments.

In some embodiments, the reaction rate of the electrode active species within an electrochemically active fluid is determined by the rate with which the species are brought close enough to the current collector to be in electrical communication, as well as the rate of the redox reaction once the electrode active species is in electrical communication with the current collector. In some instances, the transport of ions across the ionically conducting membrane may rate-limit the cell reaction. Thus the rate of charge or discharge of the flow energy storage device, or the power to energy ratio, may be relatively low. The number of electrode compartment pairs, the total area of the ion permeable medium, and/or the composition and flow rates of the electrochemically active fluids can be varied to provide sufficient power for any given application.

As noted elsewhere, in some embodiments, a first portion of the electrochemically active fluid can be charged and/or discharged while a second (or more) portion of the electrochemically active fluid is not substantially charged and/or discharged. As used herein a portion of an electrochemically active fluid is “not substantially charged and/or discharged” when the state of charge of the electrochemically active fluid is not altered by more than about 5% of the maximum state of charge of the electrochemically active fluid. In some embodiments, a portion of an electrochemically active fluid that is not substantially charged and/or discharged does not experience a change in its state of charge of more than about 2%, more than about 1%, more than about 0.1%, or more than about 0.01% of the maximum state of charge of the electrochemically active fluid. In some embodiments, an electrochemically active fluid is not substantially charged and/or discharged when the state of charge of the electrochemically active fluid does not change.

Referring back to the set of embodiments illustrated in FIGS. 1A-1B, energy storage device 100 can be operated such that a first portion 151 (illustrated in FIG. 1A as a dashed line) of electrochemically active fluid 110 is charged and/or discharged and, at the same time, a second portion 152 (also illustrated in FIG. 1A as a dashed line) of electrochemically active fluid 110 is not substantially charged and/or discharged. As mentioned elsewhere, charging and/or discharging within an isolated region of an electrochemically active fluid can be accomplished by employing relatively fast charging and/or discharging rates. In addition, the use of an electrochemically active fluid with an intermediate electronic conductivity can produce charging and/or discharging within an isolated region of an electrochemically active fluid.

The use of intermittent flow can produce considerable latitude in the choice of the material parameters of the semi-solid, and thus can be utilized for a wide variety of electrochemically active fluids and electrode active materials. Furthermore, the operating conditions during the injection and during the electrochemical cycling of the electrochemically active fluid (e.g., a semi-solid) can be varied over a wide range, and they can be varied independently. For example, the injection velocity of a fresh plug of electrochemically active fluid (e.g., semi-solid) can be varied by the working pressure, or through the geometry of the electrode compartment. For example, the energy transfer device's operating charge or discharge rate (C-rate) for a single electrode compartment volume can be adjusted by the choice of the thickness of the electrode compartment and/or the solids fraction of electrochemically active fluid.

In some embodiments, the viscosity of the electrochemically active fluid (e.g., a semi-solid suspension) is optimized by taking into account the operating pressure, fluid stream-velocity, and the geometry of the electrode compartment. In some embodiments, the injection-velocity is optimized by taking into account the viscosity, injection pressure, and/or geometrical characteristics of the electrode compartment. For example, using Hagen-Poisseiulle laminar flow, these viscosities can be computed in terms of the length and thickness of the electrode compartment. In some embodiments, the injection pressure is between about 0.1 and about 150 MPa. In some embodiments, the injection velocity is between about 0.1 and about 150 mm/s. In some embodiments, the electrode compartment thickness is between about 0.1 to about 5 mm. In some embodiments, the electrode compartment length is between about 1 and about 50 cm. Within the ranges of these embodiments, the semi-solid viscosities can be between 100 and 4×10¹¹ cP. However, in some preferred embodiments, lower viscosities can be utilized (e.g., between about 100 and about 1×10¹¹ cP to minimize mechanical dissipation and working pressures. In some embodiments, the lower bounds of viscosity will be limited by solids fraction of the semi-solid and the behavior of the suspension and, in many cases, will be larger than the lower bound quoted above.

In some embodiments, the operating ranges of the electrochemically active fluid's electronic and ionic conductivities are optimized by taking into account the rate at which charged species can be transported across the thickness of the electrode compartment, the working charge- or discharge-rate (C-rate) of the battery, the working overpotential, the energy capacity of the electrochemically active material, the fraction of electrochemically active material in the electrochemically active fluid, and/or the thickness of the electrode compartment. Requiring that the total capacity within each injected volume is extracted for each injection, the electrical conductivity required of the semi-solid can be determined. In some embodiments, loading fraction of the electrochemically active material within the electrochemically active fluid is between about 10 and about 75 vol %. In some embodiments, the volumetric energy capacity of the electrochemically active material is between about 100 and about 5000 mAh/cc. In some embodiments, the electrode compartment thickness (substantially perpendicular to fluid flow) is between about 0.1 and about 5 mm. In some embodiments, the electrode compartment length (substantially parallel to fluid flow) is between about 1 and about 50 cm. In some embodiments the C-rate is between about C/10 and about 10C. Within the ranges of these embodiments, the semi-solid electronic and ionic conductivities required for high utilization of the active material range between about 0.025 and 9.5×10⁵ mS/cm. In some preferred embodiments, higher conductivities to minimize electrical power dissipation would be utilized, and minimize polarization at a given C-rate; and the smallest of either electronic or ionic conductivity can range between about 0.01 and about 9.5×10⁵ mS/cm. In embodiments where the electronic conductivity is limited by that of carbon black, upper bounds of the electronic conductivity can be between about 0.1 and about 100 mS/cm.

In some embodiments, the ionic conductivity of the electrochemically active fluid can be between about 0.1 and about 20 mS/cm. In some embodiments, the electronic conductivity of the electrochemically active fluid can be between about 0.05 and about 20 mS/cm. In some embodiments, the viscosity of the electrochemically active fluid can be between about 1000 and about 10,000,000 Pa·s.

Restricting the transport of electrons and/or ions out of the portion of the electrochemically active fluid proximate the electrode compartment can increase the degree to which the electrons and/or ions are available to be transported within the energy storage device, for example, to and/or from ion-exchange medium 114 and/or to and/or from electrode current collector 116, which can enhance the performance of the energy storage system.

In the set of embodiments illustrated in FIG. 1A, fluid portion 153, which is also not substantially charged and/or discharged during the charge and/or discharge of fluid portion 151, is disposed on the side of electrochemically active fluid portion 151 opposite fluid portion 152. In this set of embodiments, electrochemically active fluid portion 151 forms a “plug” of fluid positioned between fluid portions 151 and 152. When arranged in this fashion, most or all of the ions and/or electrode active material participating in the electrochemical reaction within electrode compartment can be restrained from being transported to portions of the fluidic channel that are upstream (e.g., inlet channel 130) and/or downstream (e.g., outlet channel 132) of the electrode compartment. In some embodiments, the second electrode compartment can also comprise an electrochemically isolated portion of electrochemically active fluid. For example, in FIG. 1A, compartment 122 contains electrochemically active fluid portion 161 that can be charged and/or discharged while upstream fluid portion 162 and/or downstream fluid portion 163 are not substantially charged and/or discharged.

Transport of electrochemically active fluid within an energy storage system can be controlled, for example, such that only desired portions of electrochemically active fluid are present within an electrode compartment at a given time. In some embodiments, a first potion of an electrochemically active fluid can be urged into an electrode compartment while a second portion of the electrochemically active fluid is inhibited from entering the electrode compartment. In some such embodiments, the second portion of the electrochemically active fluid is in fluid communication with the first electrochemically active fluid and/or the electrode compartment via an open flow path (e.g., an open channel).

In the set of embodiments illustrated in FIG. 1A, electrochemically active fluid portion 151 can be transported from inlet channel 130 into electrode compartment 112. As fluid portion 151 is transported into electrode compartment 112, second electrochemically active fluid portion 152 can be inhibited from entering electrode compartment 112. Flow inhibition can be achieved in a variety of ways. In some embodiments, the flow of a fluid is inhibited when its flow rate is reduced. For example, inhibiting the flow rate of a fluid (e.g., an electrochemically active fluid) can involve reducing the volumetric flow rate of the fluid by at least about 50%, at least about 75%, at least about 90%, at least about 95%, or at least about 99%. In some embodiments, inhibiting the flow rate of a fluid (e.g., an electrochemically active fluid) can involve substantially stopping the flow of the fluid. In some embodiments, fluid flow can be stopped before fluid portion 152 enters the electrode compartment, for example, by employing a pump with an adjustable flow rate and/or an intermittent pump constructed and arranged to transport fluid(s) over certain periods of time and to keep the fluid(s) stationary over other periods of time. One of ordinary skill in the art, given the present disclosure, would be capable of designing a variety of other mechanisms and methods by which the second electrochemically active fluid portion can be inhibited from entering the electrode compartment.

Control of the transport of electrochemically active fluid can be useful in replacing a first portion of an electrochemically active fluid with a second portion of the electrochemically active fluid that contains electrode active material that has been charged and/or discharged to a different extent than the electrode active material in the first portion of the electrochemically active fluid. As a specific example, in some embodiments, a first portion of an electrochemically active fluid can be transported into an electrode compartment, after which flow can be inhibited. In addition, the electrode active material within the first portion of fluid can be at least partially discharged (e.g., as part of an electrochemical reaction to provide power to an external system). After the electrode active material within the first portion of electrochemically active fluid has been at least partially discharged (e.g., to less than about 90%, less than about 75%, less than about 50%, less than about 25%, less than about 10%, less than about 5%, or to substantially 0% of its maximum state of charge (SOC)), the flow rate of the electrochemically active fluid can be increased, the first portion of electrochemically active fluid can be transported out of the electrode compartment, and a second portion of electrochemically active fluid can be transported into the electrode compartment. After the second portion of the electrochemically active fluid is transported into the electrode compartment, fluid flow can be inhibited. The second portion of electrochemically active fluid can then be used to provide power, the flow rate can be increased, and the second portion of electrochemically active fluid can be removed after its electrode active material is discharged to a desirable degree. In some embodiments, each of a plurality (e.g., at least 2, at least 5, at least 10, etc.) of electrochemically isolated portions of an electrochemically active fluid can be discharged, in succession, to less than about 90%, less than about 75%, less than about 50%, less than about 25%, less than about 10%, less than about 5%, or to substantially 0% of its maximum state of charge (SOC).

As another specific example, a first portion of electrochemically active fluid can be transported into an electrode compartment, after which, flow of the electrochemically active fluid can be inhibited. The electrode active material within the first portion can be at least partially charged (e.g., so that it can be used later as part of an electrochemical reaction to provide power to an external system). After the electrode active material within the first portion of electrochemically active fluid has been at least partially charged (e.g., to a capacity of at at least about 10%, at least about 25%, at least about 50%, at least about 75%, at least about 90%, at least about 95%, or substantially all of its maximum state of charge (SOC)), the flow rate of the electrochemically active fluid can be increased, and the first portion of electrochemically active fluid can be transported out of the electrode compartment. A second portion of the electrochemically active fluid can be transported into the electrode compartment while and/or after the first portion is transported out of the electrode compartment. After the second portion has entered the electrode compartment, the flow rate of the electrochemically active fluid can be inhibited. The electrode active material within the second portion of the electrochemically active fluid can then be charged to a desirable degree, the flow rate can be increased, and the second portion can be removed from the electrode compartment. In some embodiments, each of a plurality (e.g., at least 2, at least 5, at least 10, etc.) of electrochemically isolated portions of an electrochemically active fluid can be charged, in succession, to at least about 10%, at least about 25%, at least about 50%, at least about 75%, at least about 90%, at least about 95%, or substantially all of its maximum state of charge (SOC).

In the set of embodiments illustrated in FIG. 1A, first portion 151 of electrochemically active fluid 110 can be transported from inlet channel 130 into electrode compartment 112 while a second portion 152 of electrochemically active fluid 110 can be excluded from electrode compartment 112 by inhibiting the flow of the electrochemically active fluid. The electrode active material within the first portion 151 of electrochemically active fluid 110 can be at least partially charged and/or discharged (e.g., to any of the states of charge described above) while it is located proximate electrode compartment 112. Conditions within the energy storage device (e.g., the charging and/or discharging rate, the electronic conductivity of the electrochemically active fluid, etc.) can be selected to ensure that there is substantially no electrochemical communication between portions of the electrochemically active fluid outside fluid portion 110 (e.g., at upstream locations, such as within fluid portion 152 and/or at downstream locations, such as within fluid portion 153). After the electrode active material within fluid portion 151 has been charged and/or discharged to a desired degree, the flow rate of the electrochemically active fluid can be increased, and fluid portion 151 can be transported out of electrode compartment 112. A second portion 152 of the electrochemically active fluid 110 can be transported into the electrode compartment 112 while and/or after fluid portion 151 is removed from the electrode compartment, flow can be inhibited, and fluid portion 151 can be subsequently charged and/or discharged.

In some embodiments, a third (or more) portions of the electrochemically active fluid can be transported to the electrode compartment, where they can be charged and/or discharged. For example, in the set of embodiments illustrated in FIG. 1B, a third portion of electrochemically active fluid 110 can be present in upstream portion 130 after fluid portion 152 has been transported into electrode compartment 112. In some embodiments, the third portion of the electrochemically active fluid can be inhibited from entering the electrode compartment as the second portion of the electrochemically active fluid enters the electrode compartment by using an intermittent pumping scheme and/or any of the other methods described herein. After the fluid portion within upstream channel 130 has been inhibited from entering the electrode compartment, the energy storage device can be operated such that the portion 152 of the electrochemically active fluid is charged and/or discharged while the fluid portion within upstream channel 130 is not substantially charged and/or discharged. After the electrode active material within fluid portion 152 has been charged and/or discharged to a desired degree, the flow rate of the electrochemically active fluid can be increased, fluid portion 152 can be transported out of electrode compartment 112, and the third fluid portion fluid can be transported into the electrode compartment. This process can be repeated for any suitable number of portions of the electrochemically active fluid, allowing one to repeatedly supply charged fluids (in cases where the electrode compartment is constructed and arranged to produce power) and/or discharged fluid (in cases where the electrode compartment is constructed and arranged to charge depleted electrochemically active fluid).

In some embodiments, a relatively small amount of fluid is transported through the electrode compartment between successive flow inhibition steps. For example, in some embodiments, after flow is inhibited (e.g., slowed and/or stopped) a first time, a small portion of electrochemically active fluid (e.g., a portion with a volume similar to the volume of the electrode compartment) is transported into the electrode compartment, after which flow is inhibited (slowed and/or stopped) a second time. By transporting relatively small volumes of electrochemically active fluid in between flow inhibition steps, the overall amount of energy expended to transport the fluid can be reduced. In some embodiments, the volume of electrochemically active fluid transported out of the electrode compartment from the time the flow rate is increased after a first flow inhibition step to the time the flow of electrochemically active fluid is inhibited a second time is less than about 10 times, less than about 5 times, less than about 2.5 times, or less than about 1.1 times the volume of the electrode compartment. In some embodiments, the volume of electrochemically active fluid transported out of the electrode compartment from the time the flow of electrochemically active fluid is inhibited a first time to the time the flow of electrochemically active fluid is inhibited a second time is less than about 10 times, less than about 5 times, less than about 2.5 times, or less than about 1.1 times the volume of the electrode compartment. In the set of embodiments illustrated in FIGS. 1A-1B, from the point at which fluid flow is stopped a first time (illustrated in FIG. 1A) to the point at which fluid flow is stopped a second time (illustrated in FIG. 1B), the volume of fluid transported out of electrode compartment 112 is only slightly larger than the volume of the electrode compartment 112 (and slightly larger than the volume of portion 151.

In some embodiments, multiple flow inhibition steps (e.g., at least 2, at least 5, at least 10, at least 100, or more) can be performed, and relatively small volumes of electrochemically active fluid (e.g., less than about 10 times, less than about 5 times, less than about 2.5 times, or less than about 1.1 times the volume of the electrode compartment) can be transported through an electrode compartment between each successive flow inhibition step.

As mentioned above, the flow rate of the fluid can be stopped before and/or after transporting one and/or more portions of the electrochemically active fluid into an electrode compartment. In some such embodiments, charging and/or discharging is only performed while the flow of fluid is stopped, and substantially no charging and/or discharging is performed while the fluid is flowing. For example, if the electrode compartment is being used to charge the electrochemically active fluid, a switch can be opened during fluid flow to cut off the voltage applied to the electrode current collectors, and the switch can be closed when fluid flow is stopped to apply a voltage to the electrode current collectors. If the electrode compartment is being used to discharge the electrochemically active fluid, a switch connected to an external load (e.g., circuit 180) can be opened during fluid flow to stop the flow of electricity through the external load, and the switch can be closed when flow is stopped to allow for the flow of current through the external load.

The ability to control the flow of the electrochemically active fluid within the system while charging and/or discharging only portions of the fluid can allow for a variety of useful flow arrangements. For example, in some embodiments, an electrochemically active fluid can be shuttled back and forth between a channel on one side of electrode compartment 112 (e.g., channel 130) and a channel on the opposite side of electrode compartment 112 (e.g., channel 132) by reversing the direction of fluid flow. Flow reversal can be achieved using any suitable instrumentation. For example, in some embodiments, one or more pumps can be controlled to reverse the direction of fluid flow within the system. In one set of embodiments, syringes can be attached to each of channels 130 and 132. In some such embodiments, flow can be established in the direction of arrow 128 by applying a force to the syringe connected to channel 130, and flow can be established in the direction opposite arrow 128 by applying a force to the syringe connected to channel 132.

In system 100 illustrated in FIGS. 1A-1B, electrochemically active fluid 110 can be transported through electrode compartment 112 in a first direction (e.g., the direction of arrow 128), optionally at least partially discharging portions of the fluid after inhibiting the flow of fluid one or more times. After at least a portion of fluid 110 (e.g., at least about 50%, at least about 75%, at least about 90%, or substantially all of the volume of fluid 110) has been transported through electrode compartment 112 in the first direction and at least partially discharged, the direction of flow can be reversed. After the flow direction has been reversed, isolated portions of electrochemically active fluid 110 can be charged proximate electrode compartment 112 (e.g., by applying a voltage across electrode current collectors 116 and 126 sufficiently high to induce charging). After the electrochemically active fluid has been re-charged, flow can be reversed again, after which, isolated portions of electrochemically active fluid 110 can be discharged proximate electrode compartment 112. The direction of flow of the electrochemically active fluid can be reversed any suitable number of times (e.g., at least 2 times, at least 3 times, at least 5 times, at least 10 times, at least 100 times, at least 1000 times, or more).

In some embodiments, a portion of an electrochemically active fluid can be at least partially discharged within a first volume (e.g., a first electrode compartment), urged from the first volume to a second volume different from the first volume (e.g., a second electrode compartment, a dedicated tank, or other suitable enclosure), and at least partially charged within the second volume while the second volume remains fluidically connected to the first volume. In some embodiments, the first and second volumes remain fluidically connected by a continuous flow pathway during the charging and discharging of the portion of the electrochemically active fluid. After it is charged, the portion of the electrochemically active fluid can be transported back to the first volume for subsequent discharging. Such an arrangement can allow one to shuttle portions of an electrochemically active fluid between a discharging unit (e.g., for the generation of power) and a charging unit (e.g., to replenish the discharged fluid such that it is suitable for use in the discharging unit) without having to connect or disconnect tubes, hoses, or other conduits between the two volumes.

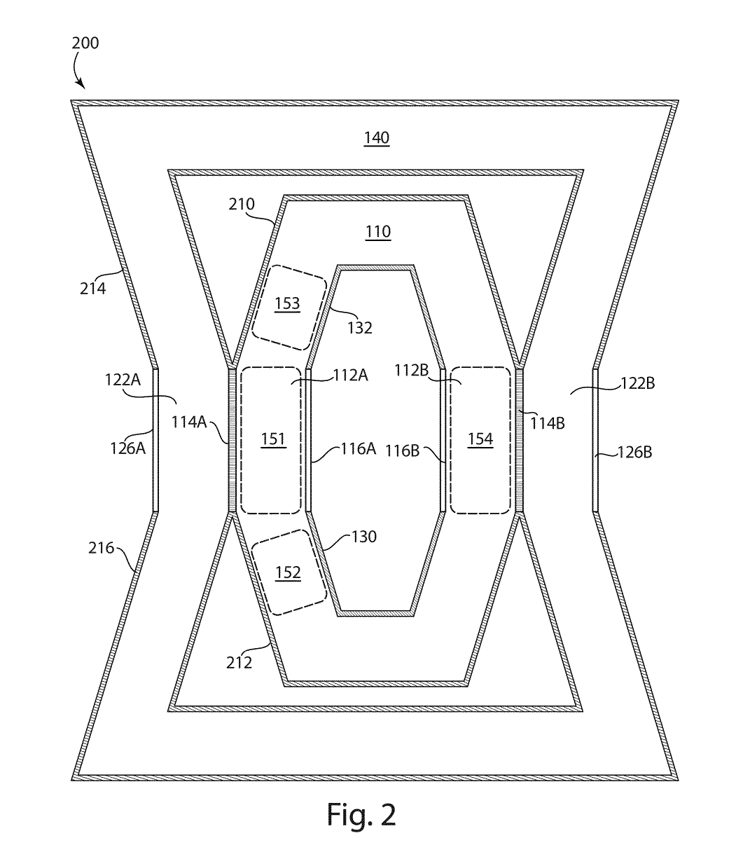

FIG. 2 includes an exemplary schematic illustration of a system 200 in which electrochemically active fluid portions are transported between charging and discharging electrode compartments. In the set of embodiments illustrated in FIG. 2, a first portion 151 of electrochemically active fluid 110 can be at least partially discharged within electrode compartment 112A while portions 152 and 153 are not substantially discharged. After electrochemically active fluid portion 151 is at least partially discharged in electrode compartment 112A, it can be transported through channel 210, and into a second electrode compartment 112B. Once fluid portion 151 has been transported into electrode compartment 112B, flow can be inhibited, and fluid portion 151 can be charged, for example, by applying electrical current across electrode current collectors 116B and 126B at a voltage sufficiently high to induce charging.

In the set of embodiments illustrated in FIG. 2, electrode compartments 112A and 112B are in fluid communication with each other such that two separate fluidic pathways (channels 212 and 210) exist simultaneously between the compartments, allowing fluid to be transported between the compartments along either of the two pathways. Once portion 151 of electrochemically active fluid 110 has been sufficiently charged in compartment 112B, it can be transported through conduit 212, and back into electrode compartment 112A. In this set of embodiments, electrode compartments 112A and 112B remain connected by conduit 210 and conduit 212 during transport of fluid 110 from electrode compartment 112A to 112B, during transport of fluid 110 from electrode compartment 112B to 112A, during the charging of fluid 110, and/or during the discharge of fluid 110.

Optionally, additional portions of the electrochemically active fluid can be charged and/or discharged during the process of charging, discharging, and/or transporting the first portion 151 of the electrochemically active fluid within the system. For example, in some embodiments, portion 154 of electrochemically active fluid 110 can be charged in electrode compartment 112B while portion 151 of electrochemically active fluid 110 is discharging in electrode compartment 112A. In addition, portions 152 and 153 of electrochemically active fluid 110 can be traveling at low velocity or stationary in conduits 212 and 210, respectively, while portion 151 of fluid 110 is discharging in electrode compartment 112A. In some embodiments, after portion 151 of fluid 110 has been transported part of the way through conduit 210 and portion 152 of electrochemically active fluid 110 has been transported into electrode compartment 112A, flow can be inhibited. Once flow is inhibited, portion 152 of electrochemically active fluid 110 can be discharged in electrode compartment 112A. Optionally, another portion of electrochemically active fluid 110 can be at least partially charged proximate electrode compartment 112B while fluid portion 152 is at least partially discharged proximate electrode compartment 112A.

While FIG. 2, illustrates a system in which a single discharging unit has been coupled to a single charging unit, it should be understood that, in other embodiments, multiple charging units can be coupled to a single discharging unit. For example, in some cases, the amount of time required to charge an electrode active material can be substantially longer than the amount of time required to discharge the electrode active material. In such cases, it can be beneficial to include multiple charging units within a fluidically connected cycle to ensure that the electrode active material is sufficiently re-charged after use prior to being reintroduced in to the discharging unit. In some embodiments, the ratio of charging units to discharging units within the fluidically connected system can be at least 1.5:1, at least 2:1, at least 3:1, between 1.5:1 and 10:1, or between 1.5:1 and 3:1.

In addition, it should be understood that, in some embodiments, an electrochemically active fluid can be circulated within an optional loop formed between electrode compartments 122A and 122B (in addition to or in place of the circulation Within the loop formed between electrode compartments 112A and 112B). In the set of embodiments illustrated in FIG. 2, electrode compartments 122A and 122B are in fluid communication with each other simultaneously via conduits 214 and 216. Of course, it should also be understood that, in other embodiments, electrode compartments 122A and 122B and/or electrode compartments 112A and 112B might not be in fluid communication. In addition, in some embodiments, one and/or more of electrode compartments 112A, 112B, 122A, and 122B might contain a conventional stationary electrode.

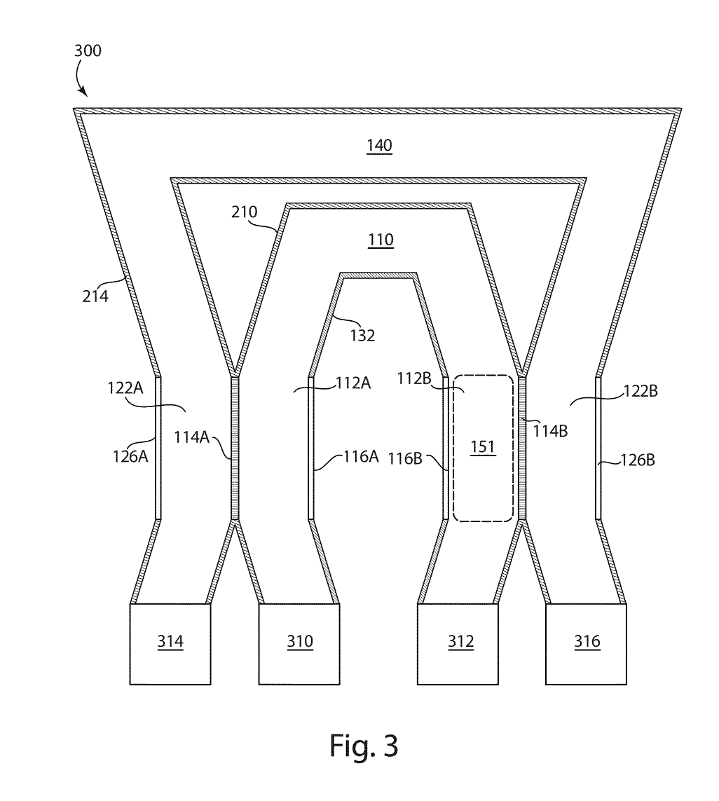

While FIG. 2 illustrates a system including two conduits fluidically connecting electrode compartment pairs 112A/112B and 122A/122B, in other embodiments more or fewer conduits can be employed. For example, in the set of embodiments illustrated in FIG. 3, electrode compartments 112A and 112B are in fluidic communication via conduit 210, and conduit 212 is not present. In addition, electrode compartments 122A and 122B are in fluidic communication via conduit 214, and conduit 216 is not present.

In some such embodiments, an electrochemically active fluid can be shuttled back and forth between electrode compartments 112A and 112B (and/or between electrode compartments 122A and 122B) by reversing the direction of fluid flow (e.g., via controlling a pump, a plurality of syringes, or any other suitable method). For example, in system 300 illustrated in FIG. 3, a first portion 151 of electrochemically active fluid 110 can be charged in electrode compartment 112B and subsequently transported to electrode compartment 112A, where it is discharged. In some embodiments, after discharging, portion 151 of fluid 110 can be transported to reservoir 310, where it can be stored for later use. After a portion (e.g., substantially all) of the electrochemically active fluid has been cycled through the system in a first direction (e.g., flowing from reservoir 312 to compartment 112B to compartment 112A and to reservoir 310), electrode compartments 112A and 122A can be altered such that they are used to charge fluids. This can be achieved, for example, by applying a current at a voltage sufficiently high to induce charging to current collectors 116A and 126A. In addition, compartments 112B and 122B can be altered such that they are used to generate power (e.g., by removing an applied voltage from current collectors 116B and 126B and applying leads to transport generated current from collectors 116B and 126B). The flow direction of the electrochemically active fluid can then be reversed such that portion 151 of fluid 110 is transported from reservoir 310 to electrode compartment 112A, where it is charged. Subsequently, fluid 110 can be transported to compartment 112B, where it is discharged. Optionally, after discharge, fluid 110 can be collected in reservoir 312 for future use. Reservoirs 314 and 316 can be incorporated into the fluidic pathway comprising electrode compartments 122A and 122B to achieve a similar result.

A variety of electrochemically active fluids can be used. In some embodiments, the electrochemically active fluid can comprise an electrode active material suspended (e.g., in the case of an insoluble electrode active material such as a lithium intercalation compound) and/or dissolved (e.g., in the case of an electrochemically active soluble salt) in a fluid that would not otherwise be electrochemically active. For example, the electrochemically active fluid, in some embodiments, comprises an electrode active material suspended and/or dissolved in an ion-conducting electrolyte. In other cases, the electrochemically active fluid can comprise a liquid that is itself electrochemically active.

In some embodiments, at least one of the positive and negative electrochemically active fluids may include a semi-solid. By “semi-solid” it is meant that the material is a mixture of liquid and solid phases, for example, such as a slurry, particle suspension, colloidal suspension, emulsion, gel, or micelle. In some embodiments, the emulsion or micelle in a semi-solid includes a solid in at least one of the liquid-containing phases. In some embodiments, the solid within the semi-solid can remain un-dissolved within the energy storage device during operation of the energy storage device, such that a solid phase remains present within the electrochemically active fluid during operation of the device.

In some embodiments, at least one of the positive and negative electrochemically active fluids can comprise a redox active ion-storing liquid (which can also be referred to as a condensed liquid ion-storing liquid). “Redox active ion-storing liquid” (or “condensed ion-storing liquid”) is used to refer to a liquid that is not merely a solvent (as in the case of an aqueous electrolyte (e.g., catholyte or anolyte)), but rather, a liquid that is itself redox-active. Of course, such a liquid form may also be diluted by or mixed with another, non-redox-active liquid that is a diluent or solvent, including mixing with such a diluent to form a lower-melting liquid phase, or emulsion or micelles including the ion-storing liquid. In some embodiments, at least one of the positive and negative electrochemically active fluids may include both a semi-solid and a redox active ion-storing liquid.

The use of a semi-solid or redox active ion-storing liquid can enhance the performance of the energy storage devices, relative to other, less energy dense materials used in other conventional systems. One distinction between a conventional redox flow battery flowable electrodes and the ion-storing solid or liquid phases described herein is the molar concentration or molarity of redox species in the storage compound. As a specific example, while redox flow batteries have many attractive features, including the fact that they can be built to almost any value of total charge capacity by increasing the size of the catholyte and anolyte reservoirs, orie of their limitations is that their energy density, being in large part determined by the solubility of the metal ion redox couples in liquid solvents, is relatively low. Conventional flowable electrodes that have redox species dissolved in aqueous solution may be limited in molarity to typically 2M to 8M concentration. Highly acidic solutions may be needed to reach the higher end of this concentration range; however, such measures which may be detrimental to other aspects of the cell operation, such as by increasing corrosion of cell components, storage vessels, and associated plumbing. Furthermore, the extent to which metal ion solubilities may be increased is limited.

By contrast, the positive and/or negative electrode active materials described herein (e.g., for use in semi-solid electrochemically active fluids) can be insoluble in the flow electrolyte, and accordingly, the concentrations of the electrode active materials are not limited by the solubility of the electrode active materials within a solvent such as an electrolyte. As one non-limiting example, the electrode active material can comprise a lithium intercalation compound suspended in an electrolyte, wherein the lithium intercalation compound is capable of taking up and/or releasing ions during operation of the device without dissolving within the electrolyte. That is to say, the lithium intercalation compound can remain in the solid phase during operation of the energy storage device. For example, in some embodiments, LiCoO₂ can be used as an electrode active material, and Li+ can be used as the active ion within an energy storage device. During operation of the device, the following electrochemical reactions can take place:

Charge: LiCoO₂→xLi⁺+xe⁻+Li₁₋ₓCoO₂

Discharge: xLi⁺+xe⁻+Li₁₋ₓCoO₂→LiCoO₂

In some such embodiments, a solid phase (e.g., Li₁₋ₓCoO₂ and LiCoO₂) remains within the electrochemically active fluid throughout the various stages of charge and discharge of the energy storage device.

Any flowable semi-solid or redox active ion-storing liquid as described herein may have, when taken in moles per liter or molarity, at least 10M, at least 12M, at least 15M, or at least 20M concentration of electrode active material. The electrode active material can be an ion storage material or any other compound or ion complex that is capable of undergoing Faradaic reaction in order to store energy. The electrode active material can also be a multiphase material including a redox-active solid or liquid phase mixed with a non-redox-active phase, including solid-liquid suspensions, or liquid-liquid multiphase mixtures; including micelles or emulsions having a liquid ion-storage material intimately mixed with a supporting liquid phase.

Systems employing electrochemically active fluids comprising semi-solid(s) and/or redox active ion-storing liquid(s) can also be advantageous because the use of such materials does not produce electrochemical byproducts in the cell. In the case of semi-solids, the electrolyte does not become contaminated with electrochemical composition products that must be removed and/or regenerated because the electrode active materials are insoluble in the electrolyte. Redox active ion-storing liquids provide a similar benefit as they are able to directly release and/or take up ions without producing by-product(s).

In some embodiments, the flowable semi-solid and/or redox active ion-storing liquid composition includes a gel.

While the use of flowable semi-solids and redox active ion-storing liquids has been described in detail above, it should be understood that the invention is not so limited, and electrochemically active fluids comprising dissolved electrode active materials (e.g., salts soluble in a fluid electrolyte) can also be used in any of the embodiments described herein.

In some embodiments, one of the positive and negative electrodes of the redox flow energy storage device includes the flowable electrode active material (e.g., a semi-solid or condensed liquid ion-storing redox composition), and the remaining electrode is a conventional stationary electrode. For example, in some embodiments, the negative electrode can be a conventional stationary electrode, while the positive electrode includes a positive flowable electrode active material. In other embodiments, the positive electrode can be a conventional stationary electrode, while the negative electrode includes a negative flowable electrode active material.

A variety of types of electrode active materials can be used in association with the embodiments described herein. Systems (including systems employing electrochemically active materials comprising semi-solid(s) and/or redox active ion-storing liquid(s)) that utilize various working ions are contemplated, including systems in which H⁺; OH⁻; Na⁺, and/or other alkali ions; Ca²⁺, Mg²⁺ and/or other alkaline earth ions; and/or Al³⁺ are used as the working ions. In addition, the electrode active material can include aqueous and/or non-aqueous components. In each of these instances, a negative electrode storage material and a positive electrode storage material may be required, the negative electrode storing the working ion of interest at a lower absolute electrical potential than the positive electrode. The cell voltage can be determined approximately by the difference in ion-storage potentials of the two ion-storage electrode materials.

In some embodiments, the electrochemically active fluid includes materials proven to work in conventional, solid lithium-ion batteries. In some embodiments, the positive electrochemically active fluid contains lithium positive electrode active materials, and lithium cations are shuttled between the negative electrode and the positive electrode, intercalating into solid, host particles suspended in a liquid electrolyte.

In some embodiments at least one of the electrochemically active fluids includes a redox active ion-storing liquid of an electrode active material, which may be organic or inorganic, and includes but is not limited to lithium metal, sodium metal, lithium-metal alloys, gallium and indium alloys with or without dissolved lithium, molten transition metal chlorides, thionyl chloride, and the like, or redox polymers and organics that are liquid under the operating conditions of the battery. Such a liquid form may also be diluted by or mixed with another, non-redox-active liquid that is a diluent or solvent, including mixing with such a diluents to form a lower-melting liquid phase. However, unlike a conventional flow cell flowable electrode, the electrode active material can comprise by mass at least 10%, or at least 25% of the total mass of the electrochemically active fluid.

In some embodiments, the electrochemically active fluid, whether in the form of a semi-solid or a redox active ion-storing liquid as described above, comprises an organic redox compound that stores the working ion of interest at a potential useful for either the positive or negative electrode of a battery. Such organic electrode active materials include “p”-doped conductive polymers such as polyaniline or polyacetylene based materials, polynitroxide or organic radical electrodes (such as those described in: H. Nishide et al., Electrochim. Acta, 50, 827-831, (2004), and K. Nakahara, et al., Chem. Phys. Lett., 359, 351-354 (2002)), carbonyl based organics, and oxocarbons and carboxylate, including compounds such as Li₂C₆O₆, Li₂C₈H₄O₄, and Li₂C₆H₄O₄ (see for example M. Armand et al., Nature Materials, DOI: 10.1038/nmat2372).

In some embodiments the electrode active material comprises a sol or gel, including for example metal oxide sols or gels produced by the hydrolysis of metal alkoxides, amongst other methods generally known as “sol-gel processing.” Vanadium oxide gels of composition VₓO_{y} are amongst such electrode active sol-gel materials.

Other suitable positive electrode active materials include solid compounds known to those skilled in the art as those used in NiMH (Nickel-Metal Hydride) Nickel Cadmium (NiCd) batteries. Still other positive electrode active materials for Li storage include those used in carbon monofluoride batteries, generally referred to as CFₓ, or metal fluoride compounds having approximate stoichiometry MF₂ or MF₃ where M comprises Fe, Bi, Ni, Co, Ti, V. Examples include those described in H. Li, P. Balaya, and J. Maier, Li-Storage via Heterogeneous Reaction in Selected Binary Metal Fluorides and Oxides, Journal of The Electrochemical Society, 151 [11] A1878-A1885 (2004), M. Bervas, A. N. Mansour, W.-S. Woon, J. F. Al-Sharab, F. Badway, F. Cosandey, L. C. Klein, and G. G. Amatucci, “Investigation of the Lithiation and Delithiation Conversion Mechanisms in a Bismuth Fluoride Nanocomposites”, J. Electrochem. Soc., 153, A799 (2006), and I. Plitz, F. Badway, J. Al-Sharab, A. DuPasquier, F. Cosandey and G. G. Amatucci, “Structure and Electrochemistry of Carbon-Metal Fluoride Nanocomposites Fabricated by a Solid State Redox Conversion Reaction”, J. Electrochem. Soc., 152, A307 (2005).

As another example, fullerenic carbon including single-wall carbon nanotubes (SWNTs), multiwall carbon nanotubes (MWNTs), or metal or metalloid nanowires may be used as electrode active materials. One example includes the silicon nanowires used as a high energy density storage material in a report by C. K. Chan, H. Peng, G. Liu, K. Mcllwrath, X. F. Zhang, R. A. Huggins, and Y. Cui, High-performance lithium battery anodes using silicon nanowires, Nature Nanotechnology, published online 16 Dec. 2007; doi:10.1038/nnano.2007.411.

Exemplary electrode active materials for the positive electrochemically active fluid in a lithium system include the general family of ordered rocksalt compounds LiMO₂ including those having the α-NaFeO₂ (so-called “layered compounds”) or orthorhombic-LiMnO₂ structure type or their derivatives of different crystal symmetry, atomic ordering, or partial substitution for the metals or oxygen. In such embodiments, M comprises at least one first-row transition metal but may include non-transition metals including but not limited to Al, Ca, Mg, or Zr. Examples of such compounds include LiCoO₂, LiCoO₂ doped with Mg, LiNiO₂, Li(Ni, Co, Al)O₂ (known as “NCA”) and Li(Ni, Mn, Co)O₂ (known as “NMC”). Other families of exemplary electrode active materials include those of spinel structure, such as LiMn₂O₄ and its derivatives, “high voltage spinels” with a potential vs. Li/Li⁺ that exceeds 4.3V including but not limited to LiNi_{0.5}Mn_{1.5}O₄, so-called “layered-spinel nanocomposites” in which the structure includes nanoscopic regions having ordered rocksalt and spinel ordering, olivines LiMPO₄ and their derivatives, in which M comprises one or more of Mn, Fe, Co, or Ni, partially fluorinated compounds such as LiVPO₄F, other “polyanion” compounds, and vanadium oxides VₓO_{y} including V₂O₅ and V₆O₁₁.

In one or more embodiments, an electrode active material comprises a transition metal polyanion compound, for example as described in U.S. Pat. No. 7,338,734. In one or more embodiments, an electrode active material comprises an alkali metal transition metal oxide or phosphate, and for example, the compound has a composition Aₓ(M′₁₋ₐM″ₐ)_{y}(XD₄)_{z}, Aₓ(M′₁₋ₐM″ₐ)_{y}(DXD₂)_{z}, or Aₓ(M′₁₋ₐM″ₐ)_{y}(X₂D₇)₂, and have values such that x, plus y(1-a) times a formal valence or valences of M′, plus ya times a formal valence or valence of M″, is equal to z times a formal valence of the XD₄, X₂D₇, or DXD₄ group; or a compound comprising a composition (M′₁₋ₐM″ₐ)ₓM′_{y}(XD)_{z}, (A₁₋ₐM″ₐ)ₓM′_{y}(DXD₄)z(M′₁₋ₐM″ₐ)ₓM′_{y}(X₂D₇)_{z} and have values such that (1-a)x plus the quantity ax times the formal valence or valences of M″ plus y times the formal valence or valences of M′ is equal to z times the formal valence of the XD₄, X₂D₇ or DXD₄ group. In such compounds, A is at least one of an alkali metal and hydrogen, M′ is a first-row transition metal, X is at least one of phosphorus, sulfur, arsenic, molybdenum, and tungsten, M″ any of a Group IIA, IIIA, IVA, VA, VIA, VIIA, VIIIA, IB, IIB, IIIB, IVB, VB, and VIB metal, D is at least one of oxygen, nitrogen, carbon, or a halogen. The positive electroactive material can be an olivine structure compound LiMPO₄, where M is one or more of V, Cr, Mn, Fe, Co, and Ni, in which the compound is optionally doped at the Li, M or O-sites. Deficiencies at the Li-site are compensated by the addition of a metal or metalloid, and deficiencies at the O-site are compensated by the addition of a halogen. In some embodiments, the positive active material comprises a thermally stable, transition-metal-doped lithium transition metal phosphate having the olivine structure and having the formula (Li₁₋ₓZₓ)MPO₄, where M is one or more of V, Cr, Mn, Fe, Co, and Ni, and Z is a non-alkali metal dopant such as one or more of Ti, Zr, Nb, Al, or Mg, and x ranges from 0.005 to 0.05.

In other embodiments, the lithium transition metal phosphate material has an overall composition of Li_{1-x-z}M_{1+z}PO₄, where M comprises at least one first row transition metal selected from the group consisting of Ti, V, Cr, Mn, Fe, Co and Ni, where x is from 0 to 1 and z can be positive or negative. In some embodiments, M includes Fe, and z is between about 0.15 and −0.15. The material can exhibit a solid solution over a composition range of 0<x<0.15, or the material can exhibit a stable solid solution over a composition range of x between 0 and at least about 0.05, or the material can exhibit a stable solid solution over a composition range of x between 0 and at least about 0.07 at room temperature (22-25° C.). The material may also exhibit a solid solution in the lithium-poor regime, e.g., where x≧0.8, or x≧0.9, or x≧0.95.

In some embodiments an electrode active material comprises a metal salt that stores an alkali ion by undergoing a displacement or conversion reaction. Examples of such compounds include metal oxides such as CoO, Co₃O₄, NiO, CuO, MnO, typically used as a negative electrode in a lithium battery, which upon reaction with Li undergo a displacement or conversion reaction to form a mixture of Li₂O and the metal constituent in the form of a more reduced oxide or the metallic form. Other examples include metal fluorides such as CuF₂, FeF₂, FeF₃, BiF₃, CoF₂, and NiF₂, which undergo a displacement or conversion reaction to form LiF and the reduced metal constituent. Such fluorides may be used as the positive electrode in a lithium battery. In other embodiments an electrode active material comprises carbon monofluoride or its derivatives.

In some embodiments the material undergoing displacement or conversion reaction is in the form of particulates having on average dimensions of 100 nanometers or less. In some embodiments the material undergoing displacement or conversion reaction comprises a nanocomposite of the active material mixed with an inactive host, including but not limited to conductive and relatively ductile compounds such as carbon, or a metal, or a metal sulfide.

In some embodiments the energy storage device is a lithium-based energy storage device (e.g., a lithium-based flow battery), and the negative electrode active compound comprises graphite, graphitic boron-carbon alloys, hard or disordered carbon, lithium titanate spinel, and/or a solid metal, metal alloy, metalloidm and/or metalloid alloy that reacts with lithium to form intermetallic compounds, including the metals Sn, Bi, Zn, Ag, and Al, and the metalloids Si and Ge. In some embodiments, Li₄Ti₅O₁₂ can be included as an electrode active material (e.g., a negative electrode active material).

Exemplary electrode active materials for the negative electrode (e.g., electrochemically active fluid) in the case of a lithium working ion include graphitic or non-graphitic carbon, amorphous carbon, or mesocarbon microbeads; an unlithiated metal or metal alloy, such as metals including one or more of Ag, Al, Au, B, Ga, Ge, In, Sb, Sn, Si, or Zn, or a lithiated metal or metal alloy including such compounds as LiAl, Li₉Al₄, Li₃M, LiZn, LiAg, Li₁₀Ag₃, Li₅B₄, Li₇B₆, Li₁₂Si₇, Li₂₁Si₈, Li₁₃Si₄, Li₂₁Si₅, Li₅Sn₂, Li₁₃Sn₅, Li₇Sn₂, Li₂₂Sn₅, Li₂Sb, Li₃Sb, LiBi, or Li₃Bi, or amorphous metal alloys of lithiated or non-lithiated compositions.

In some embodiments, the energy storage devices (e.g., SSFCs) of the present invention use Li⁺ or Na⁺ as the working ion and comprise an aqueous electrolyte. Although the use of aqueous electrolytes can, in some cases, require the use of lower potentials (to avoid the electrolytic decomposition of water) than can be used with some nonaqueous systems (e.g., conventional lithium ion systems using alkyl carbonate electrolyte solvents), the energy density of a semi-solid aqueous flow battery can be much greater than that of a conventional aqueous solution flow cell (e.g., vanadium redox or zinc-bromine chemistry) due to the much greater density of ion storage that is possible in the solid phase of a semi-solid electrochemically active fluid. Aqueous electrolytes are typically less expensive than nonaqeous electrolytes and can lower the cost of the energy storage devices, while typically also having higher ionic conductivity. In addition, aqueous electrolyte systems can be less prone to formation of insulating SEIs on the conductive solid phases used in the electrochemically active fluids and/or electrode current collectors, which can increase the impedance of the energy storage device.

The following non-limiting examples of aqueous systems show that a broad range of cathode active materials, anode active materials, electrode current collector materials, electrolytes, and combinations of such components may be used in the semi-solid aqueous flow batteries of this set of embodiments.

In some embodiments, oxides of general formula A_{X}M_{y}O_{z} may be used as electrode active materials in an aqueous or non-aqueous semi-solid flow cell, wherein A comprises a working ion that may be one or more of Na, Li, K, Mg, Ca, Al, H⁺ and/or OH⁻; M comprises a transition metal that changes its formal valence state as the working ion is intercalated or deintercalated from the compound; O corresponds to oxygen; x can have a value of 0 to 10; y can have a value of 1 to 3; and z can have a value of 2 to 7.

The aqueous or nonaqueous semi-solid flow cells may also comprise, as the semi-solid electrochemically active fluid, one or more lithium metal “polyanion” compounds, including but not limited to compounds described in U.S. Pat. No. 7,338,734, to Chiang et al. which is incorporated herein by reference in its entirety for all purposes. Such compounds include the compositions (A)ₓ(M′₁₋ₐM″ₐ)_{y}(XD₄)_{z}, Aₓ(M′₁₋ₐM″ₐ)_{y}(DXD₄)_{z}, or Aₓ(M′₁₋ₐM″ₐ)_{y}(X₂D₇)_{z}, wherein A is at least one of an alkali metal or hydrogen, M′ is a first-row transition metal, X is at least one of phosphorus, sulfur, arsenic, boron, aluminum, silicon, vanadium, molybdenum and tungsten, M″ is any of a Group IIA, IIIA, IVA, VA, VIA, VIIA, VIIIA, IB, IIB, IIIB, IVB, VB, and VIB metal, D is at least one of oxygen, nitrogen, carbon, or a halogen, 0≦a≦0.1, x is equal to or greater than 0, y and z are greater than 0 and have values such that x, plus y(1-a) times a formal valence or valences of M′, plus ya times a formal valence or valence of M″, is equal to z times a formal valence of the XD₄, X₂D₇, or DXD₄ group. In some embodiments, the compound crystallizes in an ordered or partially disordered structure of the olivine (AₓMXO₄), NASICON (Aₓ(M′,M″)₂(XO₄)₃), VOPO₄, LiFe(P₂O₇) or Fe₄(P₂O₇)₃ structure-types, and has a molar concentration of the metals (M′+M″) relative to the concentration of the elements X that exceeds the ideal stoichiometric ratio y/z of the prototype compounds by at least 0.0001.

Other such compounds comprise the compositions (A₁₋ₐM″ₐ)ₓM'_{y}(XD₄)_{z}, (A₁₋ₐM″ₐ)ₓM′_{y}(DXD₄)_{z}, or (A₁₋ₐM″ₐ)ₓM′_{y}(X₂D₇)_{z}, where A is at least one of an alkali metal or hydrogen; M′ is a first-row transition metal; X is at least one of phosphorus, sulfur, arsenic, boron, aluminum, silicon, vanadium, molybdenum and tungsten; M″ any of a Group IIA, IIIA, IVA, VA, VIA, VIIA, VIIIA, IB, IIB, IIIB, IVB, VB, and VIB metal; D is at least one of oxygen, nitrogen, carbon, or a halogen; 0≦a≦0.1; and x, y, and z are greater than zero and have values such that (1-a)x plus the quantity ax times the formal valence or valences of M″ plus y times the formal valence or valences of M′ is equal to z times the formal valence of the XD₄, X₂D₇ or DXD₄ group. In some of these embodiments, the compound crystallizes in an ordered or partially disordered structure of the olivine (AₓMXO₄), NASICON (Aₓ(M′,M″)₂(XO₄)₃), VOPO₄, LiFe(P₂O₇) or Fe₄(P₂O₇)₃ structure-types, and has a molar concentration of the metals (M′+M″) relative to the concentration of the elements X that exceeds the ideal stoichiometric ratio y/z of the prototype compounds by at least 0.0001.

Still other such compounds comprise the compositions (A_{b-a}M″ₐ)ₓM′_{y}(XD₄)_{z}, (A_{b-a}M″ₐ)ₓM′_{y}(DXD₄)_{z}, or (A_{b-a}M″ₐ)ₓM′_{y}(X₂D₇)_{z}, wherein A is at least one of an alkali metal or hydrogen; M′ is a first-row transition metal; X is at least one of phosphorus, sulfur, arsenic, boron, aluminum, silicon, vanadium, molybdenum and tungsten; M″ any of a Group IIA, IIIA, IVA, VA, VIA, VITA, VIIIA, IB, IIB, IIIB, IVB, VB, and VIB metal; D is at least one of oxygen, nitrogen, carbon, or a halogen; 0≦a≦0.1; a≦b≦1; and x, y, and z are greater than zero and have values such that (b−a)x plus the quantity ax times the formal valence or valences of M″ plus y times the formal valence or valences of M′ is equal to z times the formal valence of the XD₄, X₂D₇ or DXD₄ group. In some of these embodiments, the compound crystallizes in an ordered or partially disordered structure of the olivine (AₓMXO₄), NASICON (Aₓ(M′,M″)₂(XO₄)₃), VOPO₄, LiFe(P₂O₇) or Fe₄(P₂O₇)₃ structure-types, and has a molar concentration of the metals (M′+M″) relative to the concentration of the elements X that exceeds the ideal stoichiometric ratio y/z of the prototype compounds by at least 0.0001.

Other aqueous rechargeable lithium batteries include the following combinations of cathode active materials/anode active materials: LiMn₂O₄/VO₂, Li(Ni₁₋ₓCoₓ)O₂/LiV₃O₈, LiCoO₂/LiV₃O₈, LiMn₂O₄/TiP₂O₇, LiMn₂O₄/LiTi₂(PO₄)₃, Li(Ni_{0.33}Mn_{0.33}Co_{0.33})O₂/LiₓV₂O₅, V₂O₅/LiₓV₂O₅, LiMn₂O₄/LiₓV₂O₅, LiMn₂O₄/NaTi₂(PO₄)₃, LiMn₂O₄/Li₃Fe₂(PO₄)₃, LiMn₂O₄/LiFeP₂O₇, LiMn₂O₄/LiFe₄(P₂O₇)₃, LiCoO₂/C, Li_{0.5}Mn₂O₄/LiCoO₂, γ-MnO₂/Zn, and TiO₂ (anatase)/Zn. The semi-solid flow batteries described herein can include the use of any one or more of these cathode-active materials with any one or more of the anode-active materials. Electrode conductive additives and binders, current collector materials, current collector coatings, and electrolytes that can be used in such non-flow systems (as described herein) can also be used in the semi-solid flow batteries described herein.

In some embodiments, the flow cell can include an aqueous positive electrode active material comprising a material of the general formula LiₓFe_{y}PₐO_{z}, (wherein, for example, x can be between about 0.5 and about 1.5, y can be between about 0.5 and about 1.5, a can be between about 0.5 and about 1.5, and z can be between about 3 and about 5), and a negative electrode active material comprising a material of the general formula Li_{x′}Ti_{y′}O_{z′} (wherein, for example, x′ can be between about 3 and about 5, y′ can be between about 4 and about 6, and z′ can be between about 9 and about 15 or between about 11 and about 13). As a specific example, in some embodiments, the negative electrode active material can comprise LiFePO₄ and the positive electrode active material can comprise Li₄Ti₅O₁₂. In some embodiments, the positive and/or negative electrode active materials can include cation or anion doped derivatives of these compounds.

Other specific combinations of electrode active materials that can be used in aqueous flow cells (listed here as anode/cathode pairs) include, but are not limited to, LiV₃O₈/LiCoO₂; LiV₃O₈/LiNiO₂; LiV₃O_{8/}LiMn₂O₄; and C/Na_{0.44}MnO₂.

Sodium can be used as the working ion in conjunction with an aqueous electrolyte and cathode active or anode active compounds that intercalate sodium at suitable potentials, or that store sodium by surface adsorption and the formation of an electrical double layer as in an electrochemical capacitor or by surface adsorption accompanied by charge transfer. Materials for such systems have been described in US Patent Application US 2009/0253025, by J. Whitacre, for use in conventional (non-flow type) secondary batteries. The semi-solid flow batteries described herein can use one or more of the cathode-active materials, anode-active materials, electrode conductive additives and binders, current collector materials, current collector coatings, and electrolytes considered in such non-flow systems. One or more embodiments described herein can incorporate these materials in semi-solid flow batteries.

Cathode active materials that store sodium and can be used in an aqueous electrolyte system include, but are not limited to, layered/orthorhombic NaMO₂ (birnessite), cubic spinel λ-MnO₂ based compounds, Na₂M₃O₇, NaMPO₄, NaM₂(PO₄)₃, Na₂MPO₄F, and tunnel-structured Na_{0.44}MO₂, where M is a first-row transition metal. Specific examples include NaMnO₂, LiₓMn₂O₄ spinel into which Na is exchanged or stored, LiₓNa_{y}Mn₂O₄, Na_{y}Mn₂O₄, Na₂Mn₃O₇, NaFePO₄, Na₂FePO₄F, and Na_{0.44}MnO₂. Anode active materials can include materials that store sodium reversibly through surface adsorption and desorption, and include high surface area carbons such as activated carbons, graphite, mesoporous carbon, carbon nanotubes, and the like. They also may comprise high surface area or mesoporous or nanoscale forms of oxides such as titanium oxides, vanadium oxides, and compounds identified above as cathode active materials but which do not intercalate sodium at the operating potentials of the negative electrode.

Electrode current collector materials can be selected to be stable at the operating potentials of the positive and negative electrodes of the flow battery. In nonaqueous lithium systems the positive electrode current collector may comprise aluminum, or aluminum coated with conductive material that does not electrochemically dissolve at operating potentials of 2.5-5V with respect to Li/Li⁺. Such materials include Pt, Au, Ni, conductive metal oxides such as vanadium oxide, and carbon. The negative electrode current collector may comprise copper or other metals that do not form alloys or intermetallic compounds with lithium, carbon, and coatings comprising such materials on another conductor.

In aqueous Na⁺ and Li⁺ flow batteries the positive electrode current collector may comprise stainless steel, nickel, nickel-chromium alloys, aluminum, titanium, copper, lead and lead alloys, refractory metals, and noble metals. The negative electrode current collector may comprise stainless steel, nickel, nickel-chromium alloys, titanium, lead oxides, and noble metals. In some embodiments, the electrode current collector comprises a coating that provides electronic conductivity while passivating against corrosion of the metal. Examples of such coatings include, but are not limited to, TiN, CrN, C, CN, NiZr, NiCr, Mo, Ti, Ta, Pt, Pd, Zr, W, FeN, and CoN.

Electrolytes used in aqueous semi-solid flow cells may comprise an alkaline or alkaline earth salt dissolved in water to a concentration of 0.1M to 10M. The salt used may comprise alkali or alkaline earth metals other than the ion species stored in the intercalation electrode. Thus for lithium and sodium storing electrodes, the electrolyte may contain A₂SO₄, ANO₃, AClO₄, A₃PO₄, A₂CO₃, ACl, ANO₃, and AOH, where A comprises Li, Na, both Li and Na, or K. Alkaline earth salts include but are not limited to CaSO₄, Ca(NO₃)₂, Ca(ClO₄)₂, CaCO₃, Ca(OH)₂, MgSO₄, Mg(NO₃)₂, Mg(ClO₄)₂, MgCO₃, and Mg(OH)₂. The pH of an aqueous electrolyte may be adjusted using methods known to those of ordinary skill in the art, for example by adding OH containing salts to raise pH, or acids to lower pH, in order to adjust the voltage stability window of the electrolyte or to reduce degradation by proton exchange of certain active materials.

In some embodiments the electrode active material is present as a nanoscale, nanoparticle, or nanostructured form. This can facilitate the formation of stable liquid suspensions of the storage compound, and improves the rate of reaction when such particles are in the vicinity of the current collector. The nanoparticulates may have equiaxed shapes or have aspect ratios greater than about 3, including nanotubes, nanorods, nanowires, and nanoplatelets. Branched nanostructures such as nanotripods and nanotetrapods can also be used in some embodiments. Nanostructured electrode active materials may be prepared by a variety of methods including mechanical grinding, chemical precipitation, vapor phase reaction, laser-assisted reactions, and bio-assembly. Bio-assembly methods include, for example, using viruses having DNA programmed to template an ion-storing inorganic compound of interest, as described in K. T. Nam, D. W. Kim, P. J. Yoo, C.-Y. Chiang, N. Meethong, P. T. Hammond, Y.-M. Chiang, A. M. Belcher, “Virus enabled synthesis and assembly of nanowires for lithium ion battery electrodes,” Science, 312[5775], 885-888 (2006).

In redox cells with a semi-solid electrochemically active fluids, too fine a solid phase can inhibit the power and energy of the system by “clogging” the electrode current collectors. In one or more embodiments, the semi-solid flowable composition contains very fine primary particle sizes for high redox rate, but which are aggregated into larger agglomerates. Thus in some embodiments, the particles of solid electrode active compound in the positive and/or negative flowable redox compositions are present in a porous aggregate of 1 micrometer to 500 micrometer average diameter.

The energy storage devices can include, in some embodiments, small particles that can comprise a lubricant such as, for example, fluoropolymers such as polytetrafluoroethylene (PTFE).

In some embodiments, the electrochemically active fluid can comprise a carrier liquid that is used to suspend and transport the solid phase of a semi-solid and/or a redox active ion-storing liquid composition. The carrier liquid can be any liquid that can suspend and transport the solid phase or condensed ion-storing liquid of the flowable redox composition. In some embodiments, the carrier liquid can be an electrolyte or it can be a component of an electrolyte used to transport ions and/or electrons within the electrochemically active fluid.

By way of example, the carrier liquid can be water, a polar solvent such as alcohols or aprotic organic solvents. Numerous organic solvents have been proposed as the components of Li-ion battery electrolytes, notably a family of cyclic carbonate esters such as ethylene carbonate, propylene carbonate, butylene carbonate, and their chlorinated or fluorinated derivatives, and a family of acyclic dialkyl carbonate esters, such as dimethyl carbonate, diethyl carbonate, ethylmethyl carbonate, dipropyl carbonate, methyl propyl carbonate, ethyl propyl carbonate, dibutyl carbonate, butylmethyl carbonate, butylethyl carbonate and butylpropyl carbonate. Other solvents proposed as components of Li-ion battery electrolyte solutions include γ-butyrolactone, dimethoxyethane, tetrahydrofuran, 2-methyl tetrahydrofuran, 1,3-dioxolane, 4-methyl-1,3-dioxolane, diethyl ether, sulfolane, methylsulfolane, acetonitrile, propiononitrile, ethyl acetate, methyl propionate, ethyl propionate, dimethyl carbonate, tetraglyme, and the like. These nonaqueous solvents are typically used as multicomponent mixtures, into which a salt is dissolved to provide ionic conductivity. Exemplary salts to provide lithium conductivity include LiClO₄, LiPF₆, LiBF₄, lithium bis(pentafluorosulfonyl)imide (also referred to as LiBETI), lithium bis(trifluoromethane)sulfonimide (also referred to as LiTFSI), lithium bis(oxalato)borate (also referred to as LiBOB), and the like. As specific examples, the carrier liquid can comprise 1,3-dioxolane mixed with lithium bis(pentafluorosulfonyl)imide, for example, in a mixture of about 70:30 by mass; an alkyl carbonate mixed with LiPF₆; LiPF₆ in dimethyl carbonate DMC (e.g., at a molarity of about 1 M); LiClO₄ in 1,3-dioxolane (e.g., at a molarity of about 2 M); and/or a mixture of tratraglyme and lithium bis(pentafluorosulfonyl) imide (e.g., in a molar ratio of about 1:1).

In some embodiments, the carrier liquid used within an electrochemically active fluid (e.g., to suspend and transport a solid phase or a semi-solid and/or a redox active ion-storing liquid) and/or an electrode active material (e.g., an insoluble solid and/or salt included in the electrochemically active fluid) is selected for its ability to inhibit the formation of a solid-electrolyte interface (SEI). The formation of SEI is a phenomenon known to those of ordinary skill in the art, and is normally present in, for example, primary and secondary lithium batteries. Formation of a thin and stable SEI on the electrode can be desirable in conventional lithium-ion batteries, as it can provide controlled passivation of the electrodes against oxidation reactions (at the positive electrode) or reduction reactions (at the negative electrode) that, if allowed to continue, can consume working lithium in the cell, increase the impedance of the electrodes, introduce safety issues, or degrade the electrolyte. However, in some embodiments described herein, formation of SEI can be undesirable. For example, formation of SEI on conductive particles in the semi-solid suspension or on the surfaces of the electrode current collectors can decrease cell performance, as such films are generally electronically insulating, and can increase the internal resistance of said flow cell. Thus, it can be advantageous to select carrier liquids and/or electrode active materials that minimize SEI formation at the working potential of the positive and/or negative electrochemically active fluid. In some embodiments, the same composition (e.g., carrier fluid, salt, and/or solid electrode active material) is used in both the positive electrochemically active fluid and the negative electrochemically active fluid, and is selected to have an electrochemical stability window that includes the potentials at both electrodes or electrode current collectors of the energy storage device. In other embodiments, the components of the positive and negative electrochemically active fluid (e.g., carrier fluid, salt, and/or solid electrode active material) are separately chosen and used to enhance the performance of the positive and/or negative electrochemically active fluids (and their respective electrode current collectors). In such cases, the electrolyte phase of the semi-solid positive and negative electrochemically active fluids may be separated in the flow cell by using a separation medium (e.g., a separator membrane) that is partially or completely impermeable to the carrier liquids, while permitting facile transport of the working ion between positive and negative electrochemically active fluids. In this way, a first carrier liquid can be used in the positive electrode compartment (e.g., in the positive electrochemically active fluid), and a second, different carrier liquid can be used in the negative electrode compartment (e.g., in the negative electrochemically active fluid).

A variety of carrier liquids can be selected for advantageous use in the negative and/or positive electrochemically active fluids described herein. For example, the carrier liquid may include an ether (e.g., an acyclic ether, a cyclic ether) or a ketone (e.g., an acyclic ketone, a cyclic ketone) in some embodiments. In some cases, the carrier liquid includes a symmetric acyclic ether such as, for example, dimethyl ether, diethyl ether, di-n-propyl ether, and diisopropyl ether. In some cases, the carrier liquid includes an asymmetric acyclic ether such as, for example, ethyl methyl ether, methyl n-propyl ether, isopropyl methyl ether, methyl n-butyl ether, isobutyl methyl ether, methyl s-butyl ether, methyl t-butyl ether, ethyl isopropyl ether, ethyl n-propyl ether, ethyl n-butyl ether, ethyl i-butyl ether, ethyl s-butyl ether, and ethyl t-butyl ether. In some cases, the carrier liquid includes a cyclic ether including 5-membered rings such as, for example, tetrahydrofuran, 2-methyl tetrahydrofuran, 3-methyl tetrahydrofuran. The carrier liquid can include, in some embodiments, a cyclic ether including 6-membered rings such as, for example, tetrahydropyran, 2-methyl tetrahydropyran, 3-methyl tetrahydropyran, 4-methyl tetrahydropyran.

In some embodiments, the carrier liquid compound includes a ketone. Ketones may be advantageous for use in some embodiments due to their relatively large dipole moments, which may allow for relatively high ionic conductivity in the electrolyte. In some embodiments, the carrier liquid includes an acyclic ketone such as, for example, 2-butanone, 2-pentanone, 3-pentanone, or 3-methyl-2-butanone. The carrier liquid can include, in some cases, a cyclic ketone including cyclic ketones with 5-membered rings (e.g., cyclopentanone, 2-methyl cyclopentanone, and 3-methyl cyclopentanone) or 6-membered rings (e.g., cyclohexanone, 2-methyl cyclohexanone, 3-methyl cyclohexanone, 4-methyl cyclohexanone).

In some embodiments, the carrier liquid can include a diether, a diketone, or an ester. In some embodiments, the carrier liquid can include an acyclic diether (e.g., 1,2-dimethoxyethane, 1,2-diethoxyethane) an acyclic diketone (e.g., 2,3-butanedione, 2,3-pentanedione, 2,3-hexanedione), or an acyclic ester (e.g., ethyl acetate, ethyl propionate, methyl propionate). The carrier liquid can include a cyclic diether, in some embodiments. For example, the carrier liquid can include a cyclic diether including 5-membered rings (e.g., 1,3-dioxolane, 2-methyl-1,3-dioxolane, 4-methyl-1,3-dioxolane), or a cyclic diether including 6-membered rings (e.g., 1,3-dioxane, 2-methyl-1,3-dioxane, 4-methyl-1,3-dioxane, 1,4-dioxane, 2-methyl-1,4-dioxane). The carrier liquid can include a cyclic diketone, in some instances. For example, the carrier liquid can include a cyclic diketone including 5-membered rings (e.g., 1,2-cyclopentanedione, 1,3-cyclopentanedione, and 1H-indene-1,3(2H)-dione), or a cyclic diether including 6-membered rings (e.g., 1,2-cyclohexane dione, 1,3-cyclohexanedione, and 1,4-cyclohexanedione). In some embodiments, the carrier liquid can include a cyclic ester. For example, the carrier liquid can include a cyclic ester including 5-membered rings (e.g., gamma-butyro lactone, gamma-valero lactone), or a cyclic ester including 6-membered rings (e.g., delta-valero lactone, delta-hexa lactone).

In some cases, the carrier liquid may include a triether. In some cases, the carrier liquid may include an acyclic triether such as, for example, 1-methoxy-2-(2-methoxyethoxy)ethane, and 1-ethoxy-2-(2-ethoxyethoxy)ethane, or trimethoxymethane. In some cases, the carrier liquid can include a cyclic triether. In some embodiments, the carrier liquid can include a cyclic triether with 5-membered rings (e.g., 2-methoxy-1,3-dioxolane) or a cyclic triether with 6-membered rings (e.g., 1,3,5-trioxane, 2-methoxy-1,3-dioxane, 2-methoxy-1,4-dioxane).

The carrier liquid compound includes, in some embodiments, a carbonate (e.g., unsaturated carbonates). The carbonates may, in some cases, form an SEI at a lower potential than liquid carbonates conventionally used in commercial lithium batteries. In some instances, acyclic carbonates can be used (e.g., methyl vinyl carbonate, methyl ethynyl carbonate, methyl phenyl carbonate, phenyl vinyl carbonate, ethynyl phenyl carbonate, divinyl carbonate, diethynyl carbonate, diphenyl carbonate). In some instances, cyclic carbonates can be used such as, for example cyclic carbonates with 6-membered rings (e.g., 1,3-dioxan-2-one).

In some embodiments, the carrier liquid includes compounds that include a combination of one or more ethers, esters, and/or ketones. Such structures can be advantageous for use in some embodiments due to their relatively high dipole moments, allowing for high ionic conductivity in the electrolyte. In some embodiments, the carrier liquid includes an ether-ester (e.g., 2-methoxyethyl acetate), an ester-ketone (e.g., 3-acetyldihydro-2(3H)-furanone, 2-oxopropyl acetate), a diether-ketone (e.g., 2,5-dimethoxy-cyclopentanone, 2,6-dimethoxy-cyclohexanone), or an anhydride (e.g., acetic anhydride).

In some cases, the carrier liquid can comprise an amide. Such compounds can be acyclic (e.g., N,N-dimethyl formamide) or cyclic (e.g., 1-methyl-2-pyrrolidone, 1-methyl-2-piperidone, 1-vinyl-2-pyrrolidone).

In some embodiments, 3-methyl-1,3-oxazolidin-2-one can be used as a carrier liquid, in some cases. 3-methyl-1,3-oxazolidin-2-one may be advantageous for use in some embodiments due to its relatively high dipole moment, which would allow for high ionic conductivity in the electrolyte.

In some embodiments, the carrier liquid can include 1,3-dimethyl-2-imidazolidinone, N,N,N′,N′-tetramethylurea, or 1,3-dimethyltetrahydro-2(1H)-pyrimidinone. These compounds also include a relatively high dipole moment, which can provide advantages in some embodiments.

In some cases, the carrier liquid includes fluorinated or nitrile compounds (e.g., fluorinated or nitrile derivatives of any of the carrier liquid types mentioned herein). Such compounds may increase the stability of the fluid and allow for higher ionic conductivity of the electrolytes. Examples of such fluorinated compounds include, but are not limited to, 2,2-difluoro-1,3-dioxolane, 2,2,5,5-tetrafluorocyclopentaone, 2,2-difluoro-gama-butyrolactone, and 1-(trifluoromethyl)pyrrolidin-2-one. Examples of such nitrile compounds include, but are not limited to, tetrahydrofuran-2-carbonitrile, 1,3-dioxolane-2-carbonitrile, and 1,4-dioxane-2-carbonitrile.

In some cases, the carrier liquid includes sulfur containing compounds. In some cases, the carrier liquid can include a sulfoxide (e.g., dimethyl sulfoxide, tetrahydrothiophene 1-oxide, 1-(methylsulfonyl)ethylene), a sulfone (e.g., dimethyl sulfone, divinyl sulfone, tetrahydrothiophene 1,1-dioxide), a sulfite (e.g., 1,3,2-dioxathiolane 2-oxide, dimethyl sulfite, 1,2-propyleneglycol sulfite), or a sulfate (e.g., dimethyl sulfate, 1,3,2-dioxathiolane 2,2-dioxide). In some embodiments, the carrier liquid can include a compound with 1 sulfur and 3 oxygen atoms (e.g., methyl methanesulfonate, 1,2-oxathiolane 2,2-dioxide, 1,2-oxathiane 2,2-dioxide, methyl trifluoromethanesulfonate).

The carrier liquid includes, in some embodiments, phosphorous containing compounds such as, for example, phosphates (e.g., trimethyl phosphate) and phosphites (e.g., trimethyl phosphite). In some embodiments, the carrier liquid can include 1 phosphorus and 3 oxygen atoms (e.g., dimethyl methylphosphonate, dimethyl vinylphosphonate).

In some embodiments, the carrier liquid includes an ionic liquid. The use of ionic liquids may significantly reduce or eliminate SEI formation, in some cases. Exemplary anions suitable for use in the ionic liquid include, but are not limited to tetrafluoroborate, hexafluorophosphate, hexafluoroarsenoate, perchlorate, trifluoromethanesulfonate, bis(trifluoromethylsulfonyl)amide, and thiosaccharin anion. Suitable cations include, but are not limited to, ammonium, imidazolium, pyridinium, piperidithum or pyrrolidinium derivatives. The ionic liquid can, in some embodiments, include a combination of any one of the above anions and any one of the above cations.

The carrier liquid includes, in some cases, perfluorinated derivates of any of the carrier liquid compounds mentioned herein. A perfluorinated derivative is used to refer to compounds in which at least one hydrogen atom bonded to carbon atom is replaced by a fluorine atom. In some cases, at least half or substantially all of the hydrogen atoms bonded to a carbon atom are replaced with a fluorine atom. The presence of one or more fluorine atoms in the carrier liquid compound may, in some embodiments, allow for enhanced control over the viscosity and/or dipole moment of the molecule.

The electrochemically active fluid(s) can include various additives to improve the performance of the flowable redox cell. The liquid phase of the semi-solid in such instances can comprise a solvent, in which is dissolved an electrolyte salt, and binders, thickeners, or other additives added to improve stability, reduce gas formation, improve SEI formation on the negative electrode particles, and the like. Examples of such additives include vinylene carbonate (VC), vinylethylene carbonate (VEC), fluoroethylene carbonate (FEC), or alkyl cinnamates, to provide a stable passivation layer on the anode or thin passivation layer on the oxide cathode; propane sultone (PS), propene sultone (PrS), or ethylene thiocarbonate as antigassing agents; biphenyl (BP), cyclohexylbenzene, or partially hydrogenated terphenyls, as gassing/safety/cathode polymerization agents; or lithium bis(oxatlato)borate as an anode passivation agent.

In some embodiments, the nonaqueous positive and negative electrochemically active fluids are prevented from absorbing impurity water and generating acid (such as HF in the case of LiPF₆ salt) by incorporating compounds that getter water into the active material suspension or into the storage tanks or other plumbing of the system. Optionally, the additives are basic oxides that neutralize the acid. Such compounds include but are not limited to silica gel, calcium sulfate (for example, the product known as Drierite), aluminum oxide and aluminum hydroxide.

In some embodiments, the colloid chemistry and rheology of the semi-solid electrochemically active fluid(s) is adjusted to produce a stable suspension from which the solid particles settle only slowly or not at all, in order to improve flowability of the semi-solid and to minimize any stirring or agitation needed to avoid settling of the electrode active material particles. The stability of the electrode active material particle suspension can be evaluated by monitoring a static slurry for evidence of solid-liquid separation due to particle settling. As used herein, an electrode active material particle suspension is referred to as “stable” when there is no observable particle settling in the suspension. In some embodiments, the electrode active material particle suspension is stable for at least 5 days. Usually, the stability of the electrode active material particle suspension increases with decreased suspended particle size. In some embodiments, the particle size of the electrode active material particle suspension is less than about 10 microns. In some embodiments, the particle size of the electrode active material particle suspension is less than about 5 microns. In some embodiments, the particle size of the electrode active material particle suspension is about 2.5 microns.

In some embodiments, conductive additives are added to the electrode active material particle suspension to increase the conductivity and/or stability against particle settling of the suspension. Generally, higher volume fractions of conductive additives such as Ketjen carbon particles increase suspension stability and electronic conductivity, but excessive amount of conductive additives may also excessively increase the viscosity of the suspension. In some embodiments, the flowable redox electrode composition includes thickeners or binders to reduce settling and improve suspension stability. In some embodiments, the shear flow produced by the pumps provides additional stabilization of the suspension. In some embodiments, the flow rate is adjusted to eliminate the formation of dendrites at the electrodes.

In some embodiments, the electrode active material particles in the semi-solid are allowed to settle and are collected and stored separately, then re-mixed with the liquid to form the flow electrode as needed.

In some embodiments, the rate of charge or discharge of the redox flow battery is increased by increasing the instant amount of one or both electrode active materials in electronic communication with the current collector. In some embodiments, this is accomplished by making the semi-solid suspension more electronically conductive, so that the reaction zone is increased and extends into the electrode compartment (and, accordingly, into the electrochemically active material), but not so electronically conductive such that reaction zone extends to locations upstream and downstream of the electrode compartment. In some embodiments, the conductivity of the semi-solid suspension is increased by the addition of a conductive material, including but not limited to metals, metal carbides, metal nitrides, and forms of carbon including carbon black, graphitic carbon powder, carbon fibers, carbon microfibers, vapor-grown carbon fibers (VGCF), and fullerenes including “buckyballs”, carbon nanotubes (CNTs), multiwall carbon nanotubes (MWNTs), single wall carbon nanotubes (SWNTs), graphene sheets or aggregates of graphene sheets, and materials comprising fullerenic fragments that are not predominantly a closed shell or tube of the graphene sheet. In some embodiments, nanorod or nanowire or highly expected particulates of electrode active materials or conductive additives can be included in the semi-solid electrochemically active suspensions to improve ion storage capacity or power or both. As an example, carbon nanofilters such as VGCF (vapor growth carbon fibers), multiwall carbon nanotubes (MWNTs) or single-walled carbon nanotubes (SWNTs), may be used in the semi-solid electrochemically active suspension to improve electronic conductivity, or optionally to store the working ion.

In some embodiments, the conductivity of the electrochemically active fluid is increased by coating a solid (e.g., a solid electrode active material and/or a solid additive) in the semi-solid electrochemically active fluid with a conductive coating material which has higher electron conductivity than the solid. Non-limiting examples of conductive-coating material include carbon, a metal, metal carbide, metal nitride, metal oxide, or conductive polymer. In some embodiments, a solid of the semi-solid electrochemically active fluid is coated with metal that is redox-inert at the operating conditions of the energy storage device. In some embodiments, the solid of the semi-solid electrochemically active fluid is coated with copper to increase the conductivity of the electrode active material particle, to increase the net conductivity of the semi-solid, and/or to facilitate charge transfer between electrode active material particles and conductive additives. In some embodiments, the electrode active material particle is coated with, about 1.5% by weight, metallic copper. In some embodiments, the electrode active material particle is coated with, about 3.0% by weight, metallic copper. In some embodiments, the electrode active material particle is coated with, about 8.5% by weight, metallic copper. In some embodiments, the electrode active material particle is coated with, about 10.0% by weight, metallic copper. In some embodiments, the electrode active material particle is coated with, about 15.0% by weight, metallic copper. In some embodiments, the electrode active material particle is coated with, about 20.0% by weight, metallic copper. In general, the cycling performance of the electrochemically active fluid increases with the increases of the weight percentages of the conductive coating material. In general, the capacity of the electrochemically active fluid also increases with the increases of the weight percentages of the conductive coating material.

In some embodiments, the rate of charge or discharge of the energy storage device is increased by adjusting the interparticle interactions or colloid chemistry of the semi-solid to increase particle contact and the formation of percolating networks of the electrode active material particles. In some embodiments, the percolating networks are formed in the vicinity of the current collectors. In some embodiments, the semi-solid is shear-thinning so that it flows more easily where desired. In some embodiments, the semi-solid is shear thickening, for example so that it forms percolating networks at high shear rates such as those encountered in the vicinity of the current collector.

In some embodiments, the electrochemically active fluid is electronically conductive. Electronic conductivity can be achieved, in some embodiments, by suspending an electrically conductive solid (e.g., carbon, metal, etc.) in the electrochemically active fluid, for example, as described above. The electrochemically active fluid can be electronically conductive while in its flowing and/or non-flowing state. In some embodiments the electrochemically active fluid (which can comprise, for example, a semi-solid and/or a redox active ion-storing liquid) has an electronic conductivity of at least about 10⁻⁶ S/cm, at least about 10⁻⁵ S/cm, at least about 10⁻⁴ S/cm, or at least about 10⁻³ S/cm while it is flowing and while it is at the temperature at which the energy storage device is operated (e.g., at least one temperature between about −50° C. and about +50° C.). In some embodiments, the electrochemically active fluid has an electronic conductivity in its non-flowing state of at least about 10⁻¹⁶ S/cm, at least about 10⁻⁵ S/cm, at least about 10⁻⁴ S/cm, or at least about 10⁻³ S/cm at the temperature at which the energy storage device is operated (e.g., at least one temperature between about −50° C. and about +50° C.). As specific examples, the electrochemically active fluid can comprise a redox active ion-storing liquid having any of the electronic conductivities described herein (while flowing and/or while stationary). In some embodiments, the electrochemically active fluid comprises a semi-solid, wherein the mixture of the liquid and solid phases, when measured together, has any of the electrical conductivities described herein (while flowing and/or while stationary).

In some embodiments, the steady state shear viscosity of the electrochemically active fluid being transported through the electrode compartment(s) can be from about 1 centipoise (cP) to about 1.5×10⁶ cP or from about 1 centipoise (cP) to about 10⁶ cP at the operating temperature of the energy storage device, which may be between about −50° C. and +50° C. In some embodiments, the viscosity of the electrochemically active fluid being transported through the electrode compartment(s) is less than about 10⁵ cP. In other embodiments, the viscosity is between about 100 cP and 10⁵ cP. In embodiments in which a semi-solid is used, the volume percentage of ion-storing solid phases may be between 5% and 70%, and the total solids percentage including other solid phases such as conductive additives may be between 10% and 75%. In some embodiments, one or more electrode compartments operates at a relatively high temperature to decrease viscosity and/or increase reaction rate, while other areas of the system (e.g., storage tanks, conduits, etc.) operate at a lower temperature.

Fluid flow can be achieved using a variety of transporting devices. In some embodiments, a single transporting device can be used to introduce a fluid (e.g., an electrochemically active fluid) into a single electrode compartment, or into multiple electrode compartments in parallel. The positive and negative electrochemically active fluids can be independently cycled through an energy storage device using independent transporting devices, in some embodiments. Independent control of the positive and negative electrochemically active fluids can permit power balance to be adjusted to fluid conductivity and capacity properties.

In some embodiments, peristaltic pumps are used as the transporting device. In some embodiments, a piston pump is used to transport one or more fluids through the energy storage device. In some embodiments, an auger can be used to transport one or more fluids.

As mentioned elsewhere, the energy storage devices described herein can exhibit a relatively high specific energy. In some embodiments, the energy storage device has a relatively high specific energy at a relatively small total energy for the system, for example a specific energy of more than about 150 Wh/kg at a total energy of less than about 50 kWh, or more than about 200 Wh/kg at total energy less than about 100 kWh, or more than about 250 Wh/kg at total energy less than about 300 kWh.

Energy storage systems employing flowable semi-solid electrode active materials can result in economically viable usage-models that can be scaled from transportation and community energy storage to pumped hydroelectric storage for the national power grid. For example, the energy generation systems described herein (including SSFCs) could be used in 200-mile battery electric vehicles (BEVs). For example, assuming the use of LiCoO₂ and graphite, the densities (5.01 g/cm³ for LiCoO₂, 2.2 g/cm³ for graphite, and 1.3 g/cm³ for typical non-aqueous electrolytes), and specific capacities of these materials (cathode: 140 mAh/g for LiCoO₂,; anode: 340 mAh/g for graphite, considering a 2.5-3.5 V operating voltage) would yield an energy density of 278 Wh/kg (assuming a 50% volume fraction occupied by solid materials in the suspensions). The mass of active material needed to power a 50 kW battery electric vehicle would be approximately 180 kg, an acceptable weight by industry standards. For a grid-storage example, a similar analysis shows that an SSFC-based facility could displace a pumped hydroelectric storage facility (1.9 GW power; 15 GWh) at less than 1% of its 842-acre footprint.

The ion-exchange medium through which ions are transported within the redox flow energy storage device can include any suitable medium capable of allowing ions to be passed through it. In some embodiments, the ion-exchange medium can comprise a membrane. The membrane can be any conventional membrane that is capable of ion transport. In some embodiments, the ion-exchange medium is a liquid-impermeable membrane that permits the transport of ions therethrough, such as a solid or gel ionic conductor. In other embodiments, the ion-exchange medium is a porous polymer membrane infused with a liquid electrolyte that allows for the shuttling of ions between the anode compartment and the cathode compartment, while preventing the transfer of electrons. In some embodiments, the ion-exchange medium is a microporous membrane that prevents particles forming the positive and negative electrode flowable compositions from crossing the membrane. Exemplary ion-exchange medium materials include polyethyleneoxide (PEO) polymer in which a lithium salt is complexed to provide lithium conductivity, or Nafion™ membranes which are proton conductors. For example, PEO based electrolytes can be used as the ion-exchange medium, which is pinhole-free and a solid ionic conductor, optionally stabilized with other membranes such as glass fiber separators as supporting layers. PEO can also be used as a slurry stabilizer, dispersant, etc. in the positive or negative flowable redox compositions. PEO is stable in contact with typical alkyl carbonate-based electrolytes. This can be especially useful in phosphate-based cell chemistries with cell potential at the positive electrode that is less than about 3.6 V with respect to Li metal. The operating temperature of the redox cell can be controlled (e.g., increased and/or decreased) as necessary to improve the ionic conductivity of the ion-exchange medium.

As noted elsewhere, the electrode current collector can be electronically conductive and should be substantially electrochemically inactive under the operation conditions of the cell. Typical electrode current collectors for lithium systems include copper, aluminum, or titanium for the negative electrode current collector and aluminum for the positive electrode current collector. The electrode current collector can be in the form of a sheet, a mesh, or any other configuration for which the current collector may be distributed in the electrode compartment while permitting operation and/or fluid flow. One of ordinary skill in the art, given the present disclosure, would be capable of selecting suitable electrode current collector materials. In some embodiments, aluminum is used as the electrode current collector associated with the positive electrode compartment. In some embodiments, copper is used as the electrode current collector associated with the negative electrode compartment. In other embodiments, aluminum is used as the electrode current collector associated with the negative electrode compartment.

The following documents are incorporated herein by reference in their entirety for all purposes: U.S. patent application Ser. No. 12/484,113, filed Jun. 12, 2009, entitled “High Energy Density Redox Flow Device”; U.S. Provisional Patent Application Ser. No. 61/287,180, filed Dec. 16, 2009, entitled “High Energy Density Redox Flow Device”; U.S. Provisional Patent Application No. 61/322,599, filed Apr. 9, 2010, entitled “Energy Grid Storage Using Rechargeable Power Sources”; U.S. Provisional Patent Application No. 61/374,934, filed Aug. 18, 2010, entitled “Electrochemical Flow Cells”; U.S. Provisional Patent Application No. 61/424,033, filed Dec. 16, 2010, entitled “Energy Generation Using Electrochemically Isolated Fluids”; U.S. patent application Ser. No. 12/970,753, filed Dec. 16, 2010, entitled “High Energy Density Redox Flow Device”; U.S. Provisional Patent Application No. 61/424,021, filed Dec. 16, 2010, entitled “Stationary, Fluid Redox Electrode”; and U.S. Provisional Patent Application No. 61/424,020, filed Dec. 16, 2010, entitled “Systems and Methods for Electronically Insulating a Conductive Fluid While Maintaining Continuous Flow.” All other patents, patent applications, and documents cited herein are also hereby incorporated by reference in their entirety for all purposes.

The following examples are intended to illustrate certain embodiments of the present invention, but do not exemplify the full scope of the invention.

### EXAMPLE 1

This example describes the preparation of the materials used to perform the semi solid flow cell tests described in Examples 2-4. Table 1 includes a summary of the materials used for various components of the flow cells.

TABLE 1
Materials used in experiments described in Examples 2-4.

| | |
|---|---|
| Cathodes: | Lithium cobalt oxide (LiCoO₂) from AGC Seimi Chemical Co., Ltd. (Kanagawa, |
| | Japan) |
| Anodes: | Graphite (MCMB: Meso Carbon Micro Beads), from Osaka Gas. Co. |
| | Lithium titanate (Li₄Ti₅O₇) from Altairnano |
| Carbon | Ketjen Black from AkzoNobel |
| Additive: | |
| Electrolytes: | 1,3-dioxolane mixed with LiBETI (lithium bis(pentafluorosulfonyl) imide) |
| | (70:30 mixture by mass) (mixture abbreviated as DOL) from Novolyte Inc. |
| | alkyl carbonate mixture with LiPF₆ (SSDE), from A123 Systems |
| | 1M LiPF6 in dimethyl carbonate (DMC) from Novolyte Inc. |
| | 2M LiClO4 (99.99% pure, battery grade) in 1,3-dioxolane (99.9% pure, |
| | anhydrous) (DXL) prepared from chemicals purchased from Sigma Aldrich. |
| Separator | Celgard 2500 from Celgard LLC. |
| Films: | Tonen from Tonen Chemical Corporation. |

All of the materials were dried and stored under argon atmosphere in a glove box to prevent contamination with water or air.

Suspension Sonication: The active material and carbon (where applicable) were weighed and mixed in a 20 mL glass vial and the solid mixture was suspended by addition of electrolyte. The resulting suspension was mixed and sonicated in a Branson 1510 ultrasonic bath for a period of time ranging from 20 to 60 minutes, depending on the suspension.

Suspension Milling: For powders in which the particles were aggregated, the suspension preparation included a ball-milling step. Milling balls (Yttria Stabilized Zirconia from Advanced Materials, 5 mm in diameter) were added (50 grams for 20 mL of suspension) after the mixing of the powders with the electrolyte. The resulting mixture was sealed from air and humidity and ball milled for 24 hours in a 500 mL zirconia jar at 300 rpms. The resulting suspension was sonicated for 60 minutes.

Carbon Coating: A mixture of pyromellitic acid (from Sigma Aldrich, 96% purity) and ferrocene (from Sigma Aldrich, 96% purity) in a 6:1 ratio by weight was dissolved in acetone with vigorous stirring. The solution was added to the powder to be coated (93 parts by weight, relative to 1 part by weight ferrocene). The suspension was mixed thoroughly and then allowed to dry at 55° C. overnight in air. The dried powder was heated under high purity Ar for 10 hours at 800° C. in a quartz tube placed inside a Lindberg/Blue M furnace.

Reduction of LTO: The LTO powder was heated under a gas mixture of Ar and H2 in a 95:5 ratio at 800° C. for 20 hours in a quartz tube placed inside a Lindberg/Blue M furnace. At the end of the reduction, the color of the powder had changed from white to blue.

Copper Coating of Graphite: The graphite particles were cleaned with a 4M solution of nitric acid, then reacted with a 0.1 M SnCl₂ solution in 0.1 M HCl for 2 hours. Afterwards the particles were reacted with 0.0058 M PdCl₂ in 0.1 M HCl for 2 hours before adding 0.24 M CuSO₄.5 H₂O in a buffered solution at pH 12 until the solution had changed color from blue to gray. The copper to carbon mass ratio was determined by dissolving the metal on the particles with a solution of 35% nitric acid. The copper content in the resulting solution was determined by Luvak (722 Main St., Boylston Mass., 01505) using Direct Current Plasma Emission Spectroscopy conforming to ASTM standard E 1097-07. The Cu:MCMB mass ratio was calculated based on that result.

Gold Coating: In order to reduce the interfacial resistance at the aluminum surface of the parts used in electrochemical testing, the surfaces were coated with gold. The coating was done in a Pelco SC-7 for periods of time from 60 to 300 seconds at 40 mA.

Conductivity Measurements: The conductivities of solid suspensions in electrolyte were measured in both static and flowing conditions in a parallel plate setup. The measuring device was constructed in lab using stainless steel plates (3 mm×10 mm; 1.6 mm spacing in between the plates) and was connected to the FRA Analyzer of the 1400 Cell Test System. Conductivity was determined by varying the frequency of an AC current from 0.1 to 10⁶ Hz and analysis of the resulting Nyquist plot of imaginary vs. real parts of the resistance.

Rheological Measurements: The viscosities of particle suspensions in electrolyte were measured inside a glove box using a Brookfield Digital Viscometer, mode DV-II+ Pro Extra. The measurements were conducted as quickly as possible to minimize the degree of solvent evaporation from the suspension and modification of rheological properties. The experimental setup consisted of varying the shear rate between 5 and 35 sec⁻¹ in increments of 5 sec⁻¹. A each shear rate, 30 data points for viscosity were taken over the course of a minute. The resulting data was plotted correlating viscosity to the shear rate applied.

### EXAMPLE 2

This example describes the performance of a semi solid flow cell operated by continuously cycling the cathode or the anode. The tests described in this example were performed using half flow testing cells.

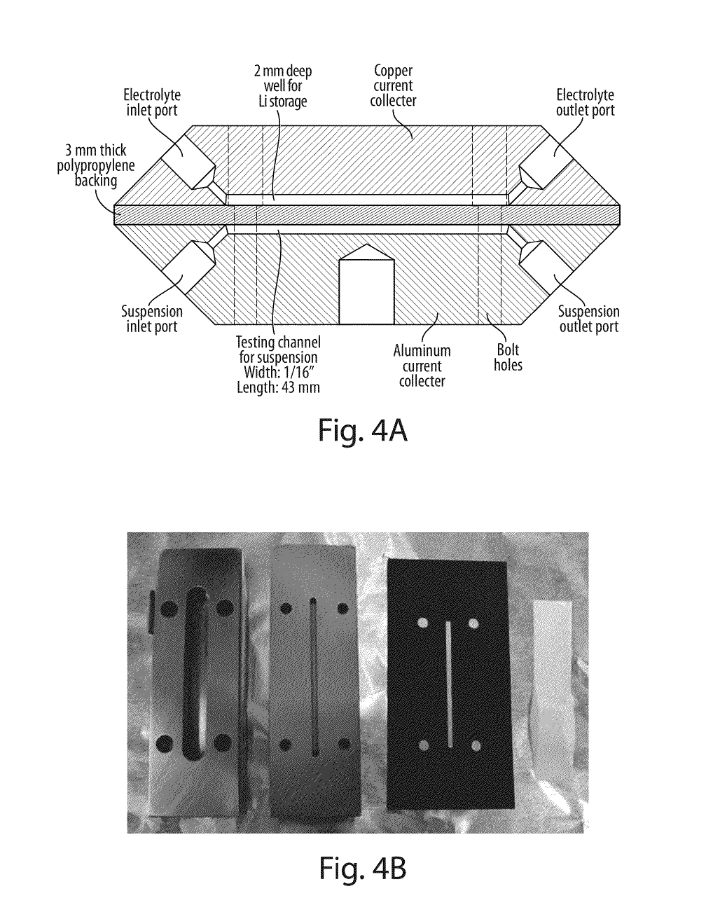

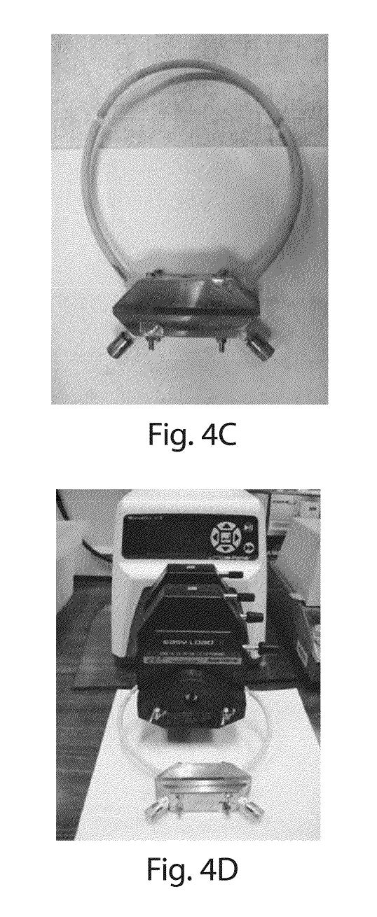

FIG. 4A includes a cross-sectional schematic illustration of an assembled half flow testing cell. The experimental setup consisted of a bottom metal piece with a 1/16″ diameter channel on top, through which the suspension was transported, a piece of separator film (Tonen) covering the channel, a piece of polypropylene with a hollowing of the same profile as the channel and a copper piece with a deep well filled with lithium metal. The parts were held together with 316 stainless steel nuts and bolts; shorting the cell was avoided with plastic washers. The two ends of the suspension-filled channel were connected on either side to a piece of Chem-Sure™ (from Gore™) with 2 pieces of Chem-Durance® (from Mastedlex) ( 1/16 inch inside diameter for all pieces of tubing). The Chem-Sure tubing was placed inside a Masterflex US peristaltic pump, which pumped the suspension at rates ranging from 0.1 to 15 mL/min. Compared to the Chem-Durance, the Chem-Sure was found to maintain elastic properties for longer periods of use in the peristaltic pump. The bottom metal part was made of copper alloy 101 for cells operating at potentials in the range 0 to 3 V vs. a Li/Li⁺ electrode and of aluminum alloy 6061 for cells operating in the range 1 to 4.5 V vs. a Li/Li⁺ electrode.

Occasionally, aluminum parts were coated with gold to reduce interfacial resistance via the method described in Example 1. Where possible, a reference electrode was inserted by replacing the separator film with two pieces of separator film containing a small amount of lithium metal pressed on a thin piece of copper foil. The bottom metal part was connected to the positive electrode, while the copper top parts were connected to the negative electrode. FIG. 4B shows a picture of the components of a half flow cell prior to assembly including: (A) the 4 mm deep Li well for the Li/Li+ electrode; (B) the 1.6 mm wide, 1.4 mm deep gold-coated aluminum testing channel; (C) the 0.017″ thick polypropylene spacer; and (D) the 14 mm×60 mm Tonen separator film. FIG. 4C includes a photo of an assembled half flow cell prepared to be tested in a continuous flow setup, while FIG. 4D shows the test cell in the Masterflex peristaltic pump. The testing was performed using a Solartron Analytical potentiostat operating the 1400 Cell Test System. Not wishing to be bound by any theory, the peristaltic pumping may have prevented settling of the particles by constantly providing energy to the suspension. With carefully chosen construction materials, half flow cells allowed repeatable charge/discharge experiments on both anode and cathode slurries.

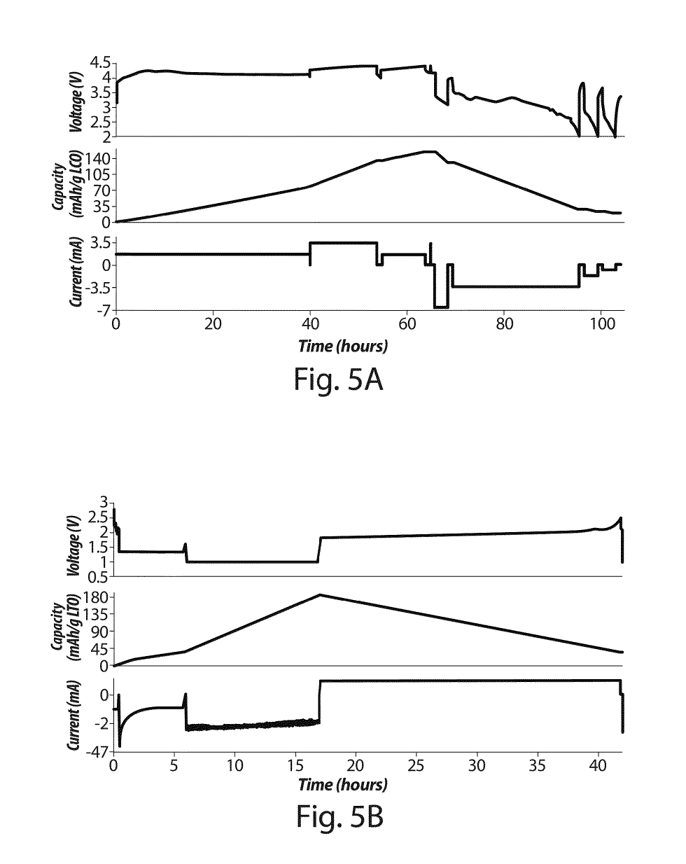

FIG. 5A includes a plot of voltage, theoretical percent charge, and current vs. time for a flowing cathode suspension tested in a half continuous flow cell setup (experiment Continuous-Flow-Cathode-1). The parameters used in this experiment are outlined in Table 1.

TABLE 2
Description of experimental setup for
“Continuous-Flow-Cathode-1”
Test type: half flow cell
Suspension composition:

| Volumetric | By mass: |
|---|---|
| 22.4% LCO | 51.3% LCO |
| 0.7% Ketjen | 0.7% Ketjen |
| 76.9% SSDE | 48.0% SSDE |

Current collector: Aluminum
Coating: N/A
Separator film: Tonen (area = 1.28 cm²)
Suspension characteristics
Theoretical energy density:

| | | |
|---|---|---|
| Volumetric: | 157.1 | Ah/L |
| Gravimetric: | 71.8 | Ah/kg |

Cell characteristics:

| | | |
|---|---|---|
| Channel volume | 0.16 | mL |
| Total volume | 0.76 | mL |
| Channel capacity | 25.1 | mAh |
| Total capacity | 119.4 | mAh |

| | |
|---|---|
| Channel C rate @ 3.3 mA | C/7 |
| Total C rate @ 3.3 mA | C/33 |

In this experiment, a cathode comprising lithium cobalt oxide suspended in SSDE electrolyte and carbon additive was tested while flowing at 20.3 mL/min through the loop constantly during the entire experiment. While the use of organic carbonate electrolytes with LiPF₆ is described in this example (and some following examples), it should be understood that a variety of electrolytes (e.g., ionic liquids, fluorinated carbonates, other polar, organic solvents and respective Li⁺ salts etc.) could be used that would produce similarly effective results. The viscosity of the suspension ranged from 2000 Pa·s at 5 s⁻¹ shear rate, to 400 Pa·s at 35 s⁻¹ shear rate. The ionic conductivity of the suspension varied under flow between 1-10 mS/cm, while the electronic conductivity of the suspension varied between 0.01-1 mS/cm.

The top curve represents the response of the cell potential to the various currents run by the cell during charge and discharge. The voltage profile shows clear plateaus during both charge and discharge, confirming that the electrochemical reaction occurred reversibly. The middle curve, the capacity profile, shows the cell charging to slightly more than the reversible capacity of lithium cobalt oxide (140 mAh/g LCO). Not wishing to be bound by any particular theory, this apparent overcharging may have been due to the flexibility of the tubing used in the experiment; as the suspension was loaded under significantly high pressure, the tubing could have been overloaded and forced to expand slightly, which would account for the extra capacity of the material. The current profile shows the rates run across the cell; the highest charge rate was C/33, while the highest discharge rate was D/16.5. Considering that the current collector area was about 20% of the total length of the loop, the cell was running, at its best, for the material in the channel, approximately instant C/7 and D/3.5 rates.

FIG. 5B includes a plot of voltage, theoretical percent charge, and current vs. time for a flowing anode suspension tested in a half continuous flow cell setup (experiment Continuous-Flow-Anode-1). The parameters used in Continuous-Flow-Anode-1 are outlined in Table 3.

TABLE 3
Description of experimental setup for “Continuous-Flow-Anode-1”
Test type: half flow cell
Suspension composition:

| Volumetric | By mass: |
|---|---|
| 5.8% LTO | 13.1% LTO |
| 1.2% Ketjen | 1.7% Ketjen |
| 93.0% DOL | 85.1% DOL |

Current collector: Aluminum
Coating: Au sputtered (300 s @ 40 mA)
Separator film: Toneu (area = 0.58 cm²)
Suspension characteristics
Theoretical energy density:

| | | |
|---|---|---|
| Volumetric: | 35.3 | Ah/L |
| Gravimetric: | 23.6 | Ah/kg |

Cell characteristics:

| | | |
|---|---|---|
| Channel volume | 89.9 | μL |
| Total volume | 0.79 | mL |
| Channel capacity | 3.1 | mAh |
| Total capacity | 27.9 | mAh |

| | |
|---|---|
| Channel D rate @ 1 mA | D/3 |
| Total D rate @ 1 mA | D/28 |

The anode included lithium titanate and a carbon additive suspended in DOL electrolyte while being flowed through the test cell at a constant rate of about 10 ml/min. The viscosity of the suspension ranged from 2000 Pa·s at 5 s⁻¹ shear rate, to 200 Pa·s at 35 s⁻¹ shear rate. The ionic conductivity of the suspension varied under flow between 0.5-7 mS/cm, while the electronic conductivity of the suspension varied between 0.01-1 mS/cm. The voltage profile illustrated a novel potentiostatic charging method, achieved by holding the cell at 1.35 and 1.0 V vs. the Li electrode. The purpose of holding the cell at a fixed voltage was to test the stability of the suspension during a charge/discharge experiment, while under constant flow. The results were encouraging as the suspension managed to charge potentistatically, then discharge galvanostatically and still flow out of the test cell at the end of the experiment. One issue which may affect energy density was the high polarization during discharge, 0.3-0.5 V; however, the instantaneous rate in the channel was D/3, considerably high for a material with relatively low electronic conductivity, such as lithium titanate. Not wishing to be bound by any particular theory, the ability of suspensions to charge and discharge under zero flow may have been due to continuous percolation through the carbon additive network, which may have increased the electronic conductivity. However, pumping rates of 20 mL/min imply that a 0.2 mL test channel was replenished more than once a second. Under such conditions, continuous percolation was, most likely, disrupted and the charge and discharge capability must be explained by other phenomena, such as transient percolation or collisions between the active material and carbon additive particles and the current collectors. The test setup raised a significant concern related to the energy needed for continuous pumping during both charge and discharge. For most suspensions, the pumping energy needed was estimated to be 10-20% of the total discharge energy, depending on the composition and energy density.

### EXAMPLE 3

This example describes the performance of an energy storage device operated by cycling the cathode under intermittent flow.

The design of the continuous flow experiment described in Example 2 placed significant limitations on the composition of the tested suspensions. Cathode mixtures in SSDE (organic carbonate electrolyte) were limited to around 25% LCO, and anode mixtures in DOL (dioxolane-based electrolyte) were limited to 15% LTO. Higher loading suspensions caused mechanical failure of the experimental setup in many cases, most often through clogging of the tubing. One way to avoid this problem was to design an intermittent flow experiment, in which the electrode active material suspensions are pumped in and out only at the beginning and end of the charge/discharge steps.

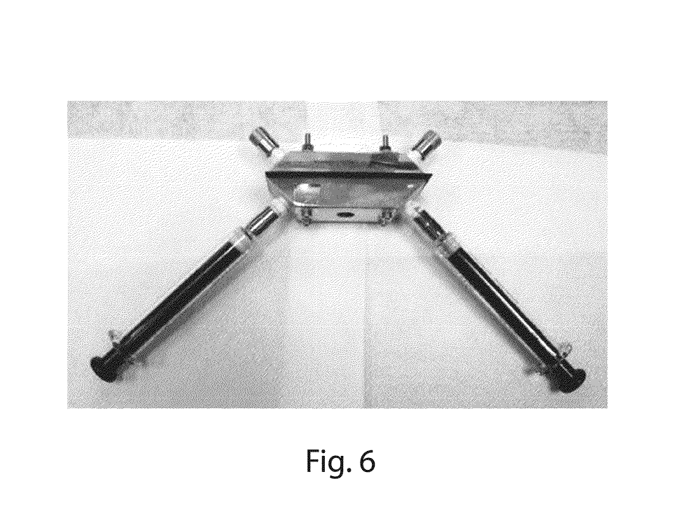

The intermittent flow tests were performed using a setup similar to that used with the constant flow tests described in Example 2. In the intermittent flow tests, the peristaltic pump and tubing system were replaced by glass syringes. FIG. 6 includes a photograph of an assembled half flow cell used in the intermittent flow tests in this example. The pumping of the suspensions was accomplished through manual control of the syringes. Suspensions which could cycle under high flow rates (such as those in experiment Continous-Flow-Cathode-1 in Example 2) showed much higher polarization at comparable rates under static conditions. Because of this, higher loadings of carbon additives were employed to reduce polarization in the intermittent flow setup. The viscosity of the suspension ranged from 10000 Pa·s at 5 s⁻¹ shear rate, to 1000 Pa·s at 35 s⁻¹ shear rate. The ionic conductivity of the suspension ranged between 1-10 mS/cm, while the electronic conductivity of the suspension varied between 0.1-10 mS/cm.

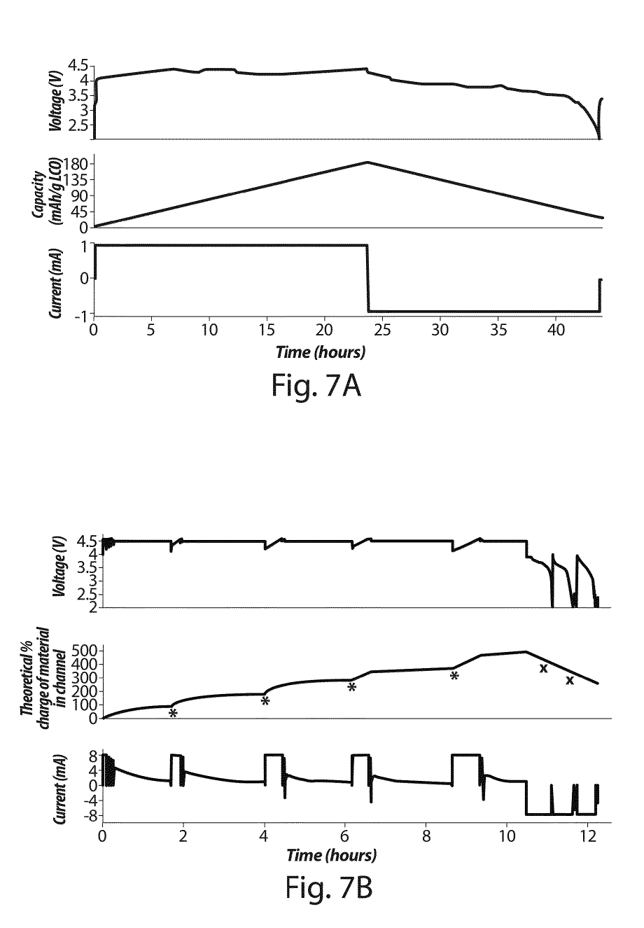

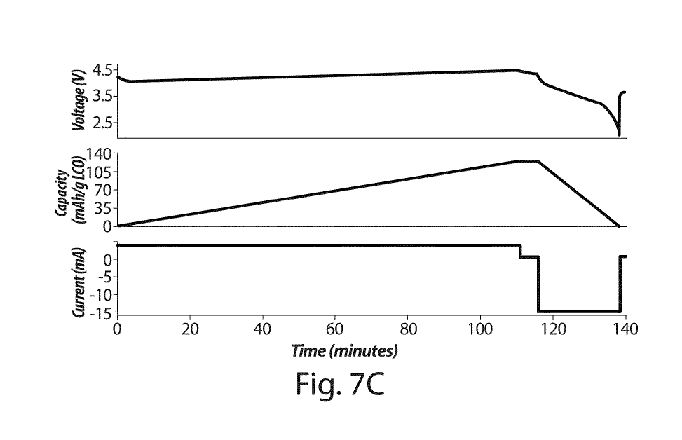

FIG. 7A includes plots of voltage, capacity, and current as a function of time for a lithium cobalt oxide suspension cycled once in the setup shown in FIG. 6, under zero flow (experiment “Intermittent-Flow-Cathode-1”). Experimental parameters for “Intermittent-Flow-Cathode-1” are outlined in Table 4.

TABLE 4
Description of experimental setup for
“Intermittent-Flow-Cathode-1”
Test type: half flow cell
Note: suspension held under zero flow
Suspension composition:

| Volumetric | By mass: |
|---|---|
| 30.0% LCO | 60.9% LCD |
| 0.8% Ketjen | 0.7% Ketjen |
| 69.2% SSDE | 38.4% SSDE |

Current collector: Aluminum
Coating: Au (300 s @ 40 mA)
Separator film: Tonen (area = 0.58 cm²)
Suspension characteristics
Theoretical energy density:

| | | |
|---|---|---|
| Volumetric: | 210.4 | Ah/L |
| Gravimetric: | 85.3 | Ah/kg |

Cell characteristics:

| | | |
|---|---|---|
| Channel volume | 89.9 | μL |
| Total volume | 89.9 | μL |
| Channel capacity | 18.8 | mAh |
| Total capacity | 18.8 | mAh |

| | |
|---|---|
| Channel C rate @ 1 mA | C/19 |
| Total C rate @ 1 mA | C/19 |

The voltage, capacity and current curves vs. time fit the expected profiles based on previous static cell results. At a C/19 rate, the specific current was 7.5 mA g⁻¹ LCO and the current density was 17.1 A m⁻² Tonen. The extra capacity was most likely due to extra charging of the suspension in portions of the inlet and outlet ports, outside the channel electrode compartment. This result suggested that intermittent flow to be a more practical substitute for continuous flow experiments.

Experiment “Intermittent-Flow-Cathode-1” showed that a suspension containing sufficient carbon additive could be charged and discharged in a flow cell setup. The next step was to charge discrete volumes of suspension, store the charged material outside the cell, then return the suspension into the cell to be discharged. The energy needed for pumping a certain volume of suspension under these conditions was calculated to be less than 0.4% of the energy stored in that volume. FIG. 7B shows a successful intermittent flow charge/discharge experiment on an lithium cobalt oxide (LCO) and Ketjen suspension in SSDE electrolyte (experiment “Intermittent-Flow-Cathode-2”). Experimental parameters for “Intermittent-Flow-Cathode-2” are outlined in Table 5.

TABLE 5
Description of experimental setup for
“Intermittent-Flow-Cathode-2”
Test type: half flow cell
Note: intermittent flow
Suspension composition:

| Volumetric | By mass: |
|---|---|
| 10.0% LCO | 28.7% LCO |
| 1.5% Ketjen | 1.9% Ketjen |
| 88.5% SSDE | 79.4% SSDE |

Current collector: Aluminum
Coating: Au (300 s @ 40 mA)
Separator film: Tonen (area = 0.58 cm²)
Suspension characteristics
Theoretical energy density:

| | | |
|---|---|---|
| Volumetric: | 70.1 | Ah/L |
| Gravimetric: | 40.2 | Ah/kg |

Cell characteristics:

| | | |
|---|---|---|
| Channel volume | 89.9 | μL |
| Total charged volume | 5 × 89.9 | μL |
| Total discharged volume | 3 × 89.9 | μL |
| Channel capacity | 6.2 | mAh |

| | |
|---|---|
| Channel C rate @ 8 mA | 1.3C |
| Channel D rate @ 8 mA | 1.3D |

In FIG. 7B, the asterisks (*) indicate the times when fresh, uncharged suspension was introduced into the electrode compartment. The x's (x) indicate the times when stored, charged suspension was introduced into the electrode compartment. At a C/19 rate, the specific current was 179.4 mA g⁻¹ LCO and the current density was 136.8 A m⁻² Tonen. The discharge power density was 478.8 W m⁻² Tonen, assuming a 3.5 V discharge potential.

The results in FIG. 7B indicate that one can successfully use the system to charge multiple volumes of suspension, store the charged material outside the cell, then return it to the test cell to be discharged. The cell was charged in a constant current, constant voltage protocol, running 1.3C galvanostatically until the cell voltage was 4.5 V, then held potentiostatically at 4.4 V for 2 hours. Relatively high current and power densities were achieved on discharge. The energy efficiency per volume of cell was estimated to be 55.6%, assuming that 0.9% of the energy was used to pump the cell.

Another experiment (“Intermittent-Flow-Cathode-3”) was performed to investigate the power density limit of the suspensions. The results of “Intermittent-Flow-Cathode-3” are shown in FIG. 7C, and the parameters for this experiment are outlined in Table 6.

TABLE 6
Description of experimental setup for
“Intermittent-Flow-Cathode-3”
Test type: half flow cell
Note: suspension held under zero flow
Suspension composition:

| Volumetric | By mass: |
|---|---|
| 10.0% LCO | 28.7% LCO |
| 2.0% Ketjen | 2.5% Ketjen |
| 88.0% SSDE | 68.8% SSDE |

Current collector: Aluminum
Coating: Au (300 s @ 40 mA)
Separator film: Tonen (area = 0.58 cm²)
Suspension characteristics
Theoretical energy density:

| | | |
|---|---|---|
| Volumetric: | 70.1 | Ah/L |
| Gravimetric: | 40.1 | Ah/kg |

Cell characteristics:

| | | |
|---|---|---|
| Channel volume | 89.9 | μL |
| Total volume | 89.9 | μL |
| Channel capacity | 6.2 | mAh |
| Total capacity | 6.2 | mAh |

| | |
|---|---|
| C rate @ 3.1 mA | C/2 |
| D rate @ −15 mA | 2.5 D |

In “Intermittent-Flow-Cathode-3,” a single charge/discharge experiment was performed using a lithium cobalt oxide (LCO) suspension with a high carbon (Ketjen black) loading in SSDE electrolyte. The charge rate was lower than the discharge rate to prevent dangerous lithium dendrite formation during delithiation (charging) of the cathode suspension. In this test, the power density on discharge was relatively high (about 1000 W/m²), which approaches the required range for automotive applications (5000-10000 W/m²). Not wishing to be bound by any particular theory, the energy efficiency, 82%, may have been higher than in experiment “Intermittent-Flow-Cathode-2” for any of several reasons. First, the charge rate in “Intermittent-Flow-Cathode-3” was somewhat lower, meaning that the polarization was reduced during delithiation of the material. Second, the test cell in “Intermittent-Flow-Cathode-3” was modified to employ thinner spacers (0.017″ polypropylene spacers instead of 0.12″; see FIG. 4B) and reduced the IR drop across solvent-filled volumes in the cell during both charge and discharge.

It is interesting to note the differences in the current densities observed between experiments “Intermittent-Flow-Cathode-1” and “Intermittent-Flow-Cathode-2.” A mixture with 30% LCO and 0.8% Ketjen by volume was highly polarized at 17.1 A m⁻² while the 10% LCO, 1.5% Ketjen was able to handle eight times that rate. Not wishing to be bound by any particular theory, the difference in rate capability may have been due to the differences in cell design between the static and flow setups. First, the static cell has a shorter distance to the nearest segment of current collector, <0.5 mm on average, compared to ˜0.8 mm in a flow cell setup. Moreover, the half flow setup has extra volume available on the Li side for mossy lithium to be stored during the charging of the cathode material. This volume is filled only with the electrolyte which causes a significant IR drop directly proportional to the current applied. Meanwhile, not allowing sufficient space for Li deposition during LCO charge can result in formation of Li dendrites which penetrate through the separator film and short the cell. Both of these problems can easily be avoided in a full flow cell in which the anode is another suspension that can uptake Li, and there are no gaps between the anode and cathode sides.

One significant advantage intermittent flow cells have over continuous flow cells is that intermittent flow cells can require much less energy to pump the electrode active material suspension. Table 7 presents comparative energy estimates for intermittent vs. continuous flow experiments on a 22.4% LCO, 0.7% Ketjen in SSDE suspension. The energy needed for pumping was estimated assuming the work needed to move the suspension was equal to the product of the pressure applied and the volume displaced (20 N for a channel volume). The energy stored in the system was estimated assuming full LCO charge and discharge at 3.5 V. The flow test was assumed to take 80 hours at 10 mL/min flow rate through 20 cm of tubing and channel. The calculation shows a clear advantage for the intermittent flow setup. Theoretically, using more concentrated suspensions with higher loadings of LCO would increase the amount of energy produced and decrease the percentage of energy used for pumping; however, more concentrated suspensions are more viscous and require more energy for pumping, using up more of the stored energy of the suspension.

TABLE 7
Comparative energy estimates for pumping suspensions
in continuous and intermittent flow.

| Experiment type | Continuous flow | | Intermittent flow | |
|---|---|---|---|---|
| Volume considered | Tubing + channel = | | Channel = | |
| | 0.99 mL | | 0.089 mL | |
| Energy to circulate through | 3.38 mJ | | 220 mJ | |
| system once | (assuming 10 mL/ | | (for filling | |
| | min flow rate) | | channel once) | |
| # of refills needed | 120000 | | 2 | |
| Total flow energy | 407 J = 0.11 Wh | | 0.440 J = 1.2 · | |
| | | | 10⁻⁴ Wh | |
| Energy density of suspension | 0.49 | Wh/L | 0.49 | Wh/L |
| Maximum discharge energy | 0.49 | Wh | 0.043 | Wh |

| | | |
|---|---|---|
| % energy expended on flowing | 22.40% | 0.28% |

Some main factors that reduce the energy efficiency of the cell include polarization drops (which are common for all types of batteries) and pumping losses (which are common for redox flow cells in which the active material must be pumped continuously to bring material in contact with the current collectors). The solid suspension flow cell model includes several advantages aimed at increasing energy efficiency. By using carbon additives, conductive networks can be formed which eliminate the need for continuous pumping of the suspensions. Moreover, the percolating networks also reduce the polarization drops across the cell, increasing the overall energy efficiency.

### EXAMPLE 4

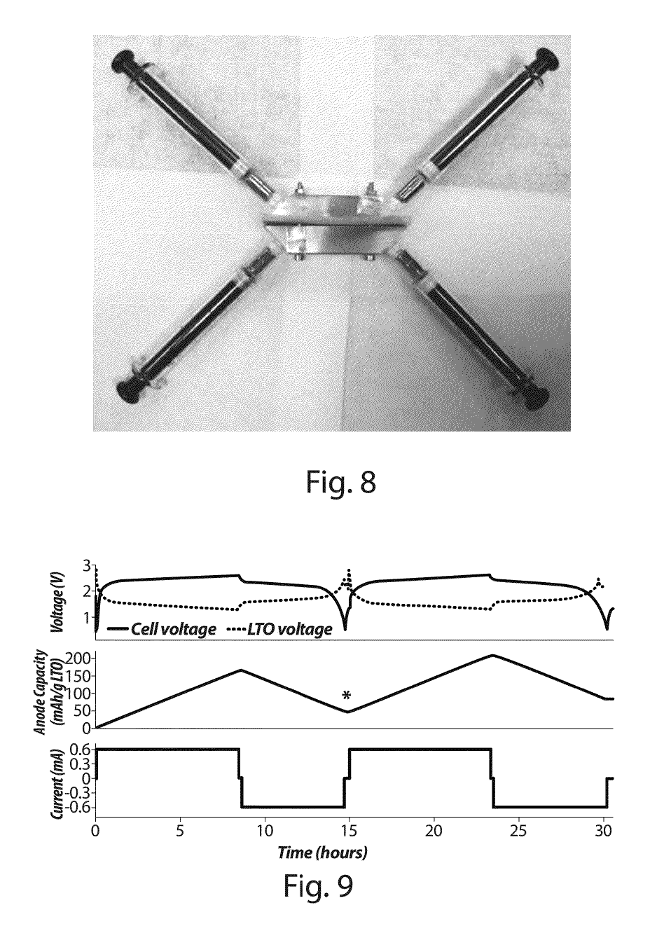

This example describes the performance of an energy storage device operated by cycling both the anode and the cathode under intermittent flow. FIG. 8 includes a photograph of a system used for intermittently cycling both the anode and the cathode. The system used in this example was the same as that used in the experiments described in Example 3, except that for these experiments, glass syringes were used to inject electrode active material into both the anodic and cathodic compartments of the flow cell device.

FIG. 9 includes a plot of voltage, capacity, and current for two complete charge/discharge cycles for a full cell operating under intermittent flow conditions in both the anode and the cathode (experiment “Intermittent-Flow-Full-1”). The cathode was lithium cobalt oxide and the anode was lithium titanate, both of which were suspended in a mixture of carbon additive and DMC electrolyte. Because of the lower loading limit of the lithium titanate in suspension, as well as the narrower low-voltage stability range of DMC, the anode was capacity limiting. Table 8 outlines the experimental parameters for the “Intermittent-Flow-Full-1” experiment. The viscosity of the cathode suspension ranged from 10000 Pa·s at 5 s⁻¹ shear rate, to 1000 Pa·s at 35 s⁻¹ shear rate. The ionic conductivity of the cathode suspension ranged between 1-10 mS/cm, while the electronic conductivity of the suspension between 0.1-10 mS/cm. The viscosity of the anode suspension ranged from 10000 Pa·s at 5 s⁻¹ shear rate, to 1000 Pa·s at 35 s⁻¹ shear rate. The ionic conductivity of the anode suspension ranged between 1-10 mS/cm, while the electronic conductivity of the suspension between 0.1-10 mS/cm.

TABLE 8
Description of experimental setup for “Intermittent-Flow-Full-1”

| Type: full intermittent flow cell | Separator film: Tonen |
|---|---|
| Cathode current collector: Al | Coating: Au (300 s @ 40 mA) |
| Anode current collector: Al | Coating: Au (300 s @ 40 mA) |

| | |
|---|---|
| Cathode composition | Anode composition |

| Volumetric | By mass: | Volumetric | By mass: |
|---|---|---|---|
| 20.0% LCD | 48.0% LCO | 10.0% LTO | 21.0% LTO |
| 1.5% Ketjen | 1.5% Ketjen | 2.0% Ketjen | 2.7% Ketjen |
| 78.6% DMC | 50.5% DMC | 88.0% DMC | 74.3% DMC |

| Side | | |
|---|---|---|
| Position | Top | Bottom |
| Active material | LCO | LTO |
| Electrolyte | DMC | DMC |

| | | | | |
|---|---|---|---|---|
| Volumetric capacity | 140.1 | Ah/L | 58.8 | Ah/L |
| Specific capacity | 65.4 | Ah/kg | 52.3 | Ah/kg |
| Channel volume | 0.09 | mL | 0.09 | mL |
| Cell capacity | 12.5 | mAh | 5.23 | mAh |

| | | |
|---|---|---|
| C rate @ 300 A | C/20 | C/8 |

In this experiment, at a C/8 rate, the current density was 10.3 A m⁻². After one complete cycle, the test cell was refilled with fresh, uncharged material on both the anode and cathode sides. In FIG. 9, the asterisk (*) indicates the time at which fresh uncharged suspension was inserted into the electrode compartments. The top curve, the voltage profile, shows the operating cell voltage (a) and the voltage of the anode suspension (b, which was measured using a reference electrode). The cell voltage was situated in the correct range (around 2.3 V) while the anode voltage plateaued around 1.5 V, as expected. The spike in the anode voltage after the first cycle was due to insertion of fresh, uncharged lithium titanate material. The capacity profile (middle graph) shows some irreversible capacity loss, which may have been due to partial SEI formation on the anode side. The current profile (lower graph) shows two consecutive galvanostatic charge/discharge experiments. These results show that both compartments of a flow cell can operate under intermittent flow.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A method of transferring energy in an energy storage device, comprising:
transporting an electrochemically active fluid through an electrode compartment;
inhibiting the flow of the electrochemically active fluid;
during and/or after inhibiting the flow of the electrochemically active fluid, at least partially charging or discharging a first portion of the electrochemically active fluid while, at the same time, a second portion of the electrochemically active fluid fluidically connected to the first portion via an open flow path is not substantially charged or discharged.

2. A method as in claim 1, wherein inhibiting the flow of the electrochemically active fluid comprises reducing the volumetric flow rate of the electrochemically active fluid by at least about 50%.

3. A method as in claim 1, wherein inhibiting the flow of the electrochemically active fluid comprises substantially stopping the flow of the electrochemically active fluid.

4. A method as in claim 1, further comprising, after the first electrochemically active fluid is at least partially discharged:
increasing the flow rate of the electrochemically active fluid;
transporting the first portion of the electrochemically fluid out of the electrode compartment; and
transporting the second portion of the electrochemically active fluid into the electrode compartment.

5. A method as in claim 4, further comprising, after transporting the second portion of the electrochemically active fluid into the electrode compartment, inhibiting the flow of the electrochemically active fluid for a second time.

6. A method as in claim 5, wherein the volume of electrochemically active fluid transported out of the electrode compartment from the time the flow rate is increased to the time the flow of electrochemically active fluid is inhibited for the second time is less than about 10 times the volume of the electrode compartment.

7. A method as in claim 5, wherein the volume of electrochemically active fluid transported out of the electrode compartment from the time the flow rate is increased to the time the flow of electrochemically active fluid is inhibited for the second time is less than about 5 times the volume of the electrode compartment.

8. A method as in claim 5, wherein the volume of electrochemically active fluid transported out of the electrode compartment from the time the flow rate is increased to the time the flow of electrochemically active fluid is inhibited for the second time is less than about 1.1 times the volume of the electrode compartment.

9. A method as in claim 1, further comprising transporting a second electrochemically active fluid through a second electrode compartment, wherein at least a portion of the second electrochemically active fluid is in electrochemical communication with at least a portion of the first electrochemically active fluid.

10. A method as in claim 1, wherein the electrochemically active fluid is in electrochemical communication with a solid electrode within a second electrode compartment.

11. A method of transferring energy in an energy storage device, comprising:
at least partially discharging a first portion of an electrochemically active fluid within a first volume;
urging the first portion of the electrochemically active fluid from the first volume to a second volume; and
at least partially charging the first portion of the electrochemically active fluid within the second volume,
wherein the first and second volumes remain fluidically connected by a continuous, open conduit during the charging and discharging of the first portion of the electrochemically active fluid.

12. A method as in claim 11, wherein the first volume comprises an electrode compartment.

13. A method as in claim 11, wherein the second volume comprises an electrode compartment.

14. A method as in claim 1, wherein the ionic conductivity of a working ion within the electrochemically active fluid is at least about 0.001 mS/cm.

15. A method as in claim 1, wherein the electrochemically active fluid comprises a semi-solid.

16. A method as in claim 15, wherein the semi-solid comprises a solid electrode active material suspended in an electrolyte.

17. A method as in claim 16, wherein the electrode active material and the electrolyte are selected such that the electrode active material does not dissolve within the electrolyte during operation of the electrochemical cell.

18. A method as in claim 1, wherein the electrochemically active fluid comprises a redox active ion-storing liquid.

19. A method as in claim 1, wherein the electrode compartment is bounded by an ion-exchange medium.

20. A method as in claim 1, wherein the electrochemically active fluid contains Li⁺Na⁺, Mg²⁺, Al³⁺, Ca²⁺, H⁺, and/or OH⁻,

21. A method as in claim 1, wherein the electronic conductivity within the electrochemically active fluid is at least about 10⁻⁶ S/cm.
